(19) United States
(12) Patent Application Publication
(10) Pub. No.: US 2025/0175643 A1
(43) Pub. Date: May 29, 2025

(54) DEVICE FOR TRANSMITTING POINT CLOUD DATA, METHOD FOR TRANSMITTING POINT CLOUD DATA, DEVICE FOR RECEIVING POINT CLOUD DATA, AND METHOD FOR RECEIVING POINT CLOUD DATA

(71) Applicant: LG ELECTRONICS INC., Seoul (KR)

(72) Inventor: Hyejung HUR, Daejeon (KR)

(21) Appl. No.: 18/836,652

(22) PCT Filed: Feb. 7, 2023
(86) PCT No.: PCT/KR2023/001730

§ 371 Date: Aug. 7, 2024

(30) Foreign Application Priority Data
Feb. 7, 2022 (KR) 10-2022-015190

(51) Int. Cl. H04N 19/597; G01S 17/89; G06T 17/00; H04N 19/513

(52) U.S. Cl. CPC H04N 19/597; G01S 17/89; G06T 17/00; H04N 19/513

(57) ABSTRACT

Disclosed are a method for transmitting point cloud data, a device for transmitting cloud data, a method for receiving cloud data, and a device for receiving cloud data according to embodiments. The method for transmitting point cloud data according to embodiments may comprise the steps of: obtaining point cloud data including points through lidar equipment equipped with laser sensors; encoding the point cloud data; and transmitting the encoded point cloud data and signaling data.

### TECHNICAL FIELD

Embodiments relate to a method and apparatus for processing point cloud content.

### BACKGROUND ART

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), XR (Extended Reality), and self-driving services. However, tens of thousands to hundreds of thousands of point data are required to represent point cloud content. Therefore, there is a need for a method for efficiently processing a large amount of point data.

### DISCLOSURE

### Technical Problem

An object of the present disclosure devised to solve the above-described problems is to provide a point cloud data transmission device, a point cloud data transmission method, a point cloud data reception device, and a point cloud data reception method for efficiently transmitting and receiving a point cloud.

Another object of the present disclosure is to provide a point cloud data transmission device, a point cloud data transmission method, a point cloud data reception device, and a point cloud data reception method for addressing latency and encoding/decoding complexity.

Another object of the present disclosure is to provide a point cloud data transmission device, a point cloud data transmission method, a point cloud data reception device, and a point cloud data reception method for improving the compression performance of the point cloud by improving the technique of encoding attribute information of geometry-based point cloud compression (G-PCC).

Another object of the present disclosure is to provide a point cloud data transmission device, a point cloud data transmission method, a point cloud data reception device, and a point cloud data reception method for efficiently compressing and transmitting point cloud data captured by LiDAR equipment and receiving the same.

Another object of the present disclosure is to provide a point cloud data transmission device, a point cloud data transmission method, a point cloud data reception device, and a point cloud data reception method for efficient compression of point cloud data captured by LiDAR equipment.

Another object of the present disclosure is to provide a point cloud data transmission device, a point cloud data transmission method, a point cloud data reception device, and a point cloud data reception method for classifying point cloud data into roads and objects for efficient compression of point cloud data captured by LiDAR equipment.

Embodiments are not limited to the above-described objects, and the scope of the embodiments may be extended to other objects that can be inferred by those skilled in the art based on the entire contents of the present disclosure.

### Technical Solution

To achieve these objects and other advantages and in accordance with the purpose of the disclosure, as embodied and broadly described herein, a method of transmitting point cloud data according to embodiments may include acquiring point cloud data including points through LiDAR equipment having laser sensors, encoding the point cloud data, and transmitting the encoded point cloud data and signaling data:

According to embodiments, the encoding may include splitting the points of the point cloud data into a road and an object based on radius information about the points, generating a prediction unit composed of the points split into the road and a prediction unit composed of the points split into the object, and compressing the point cloud data by selectively applying a motion vector to each of the prediction units,

According to embodiments, the signaling data may include information related to the splitting into the road and the object.

According to embodiments, the splitting into the road and the object may include removing points present within a minimum radius among points acquired through a current laser sensor and splitting remaining points among the acquired points into the road and the object.

According to embodiments, the splitting into the road and the object may include splitting points present within a minimum radius among points acquired through a current laser sensor into the road.

According to embodiments, the splitting into the road and the object may include obtaining an average radius of radii at which the points are located for the laser sensors, splitting, based on a radius of the points acquired through a current laser sensor being less than the average radius at a previous laser sensor, the points into the object, and splitting, based on the radius not being less than the average radius, the points into the road.

According to embodiments, the splitting into the road and the object may include excluding, from the average radius, points located at a radius greater than a specific threshold among the points.

According to embodiments, the splitting into the road and the object may include, splitting, based on a radius at successive azimuths at the same laser sensor being outside a specific range, corresponding points into the object, and based on the radius not being outside the specific range, splitting the corresponding points into the road.

According to embodiments, the splitting into the road and the object may include predicting radii at which the points are located for the laser sensors and obtaining an expected radius, splitting, based on a radius of the points acquired through a current laser sensor being less than an expected radius at a previous laser sensor, the points into the object, and splitting, based on the radius not being less than the expected radius, the points into the road.

According to embodiments, motion compensation may be performed on the prediction unit composed of the points split into the object by applying the motion vector. The motion compensation may be skipped for the prediction unit composed of the points split into the road.

According to embodiments, a device for transmitting point cloud data may include an acquirer configured to acquire point cloud data including points through LiDAR equipment having laser sensors, an encoder configured to encode the point cloud data, and a transmitter configured to transmit the encoded point cloud data and signaling data.

According to embodiments, the encoder may include a road/object splitter configured to split the points of the point cloud data into a road and an object based on radius information about the points, a prediction unit splitter configured to generate a prediction unit composed of the points split into the road and a prediction unit composed of the points split into the object, and a compressor configured to compress the point cloud data by selectively applying a motion vector to each of the prediction units,

According to embodiments, the signaling data may include information related to the splitting into the road and the object.

According to embodiments, the road/object splitter may remove points present within a minimum radius among points acquired through a current laser sensor, and split remaining points among the acquired points into the road and the object.

According to embodiments, the road/object splitter may be configured to obtain an average radius of radii at which the points are located for the laser sensors, split, based on a radius of the points acquired through a current laser sensor being less than the average radius at a previous laser sensor, the points into the object, and split, based on the radius not being less than the average radius, the points into the road.

According to embodiments, the road/object splitter may exclude, from the average radius, points located at a radius greater than a specific threshold among the points.

According to embodiments, the road/object splitter may be configured to split, based on a radius at successive azimuths at the same laser sensor being outside a specific range, corresponding points into the object, and split, based on the radius not being outside the specific range, the corresponding points into the road.

According to embodiments, the road/object splitter may be configured to predict radii at which the points are located for the laser sensors and obtaining an expected radius, split, based on a radius of the points acquired through a current laser sensor being less than an expected radius at a previous laser sensor, the points into the object, and split, based on the radius not being less than the expected radius, the points into the road.

According to embodiments, motion compensation may be performed on the prediction unit composed of the points split into the object by applying the motion vector. The motion compensation may be skipped for the prediction unit composed of the points split into the road.

### Advantageous Effects

The point cloud data transmission method, the point cloud data transmission device, the point cloud data reception method, and the reception device according to embodiments may provide a quality point cloud service.

The point cloud data transmission method, point cloud data transmission device, point cloud data reception method, and point cloud data reception device according to embodiments may achieve various video codec methods.

The point cloud data transmission method, point cloud data transmission device, point cloud data reception method, and point cloud data reception device according to embodiments may provide universal point cloud content such as an autonomous driving service.

The point cloud data transmission method, point cloud data transmission device, point cloud data reception method, and point cloud data reception device according to embodiments may perform space-adaptive partition of point cloud data for independent encoding and decoding of the point cloud data, thereby improving parallel processing and providing scalability.

The point cloud data transmission method, point cloud data transmission device, point cloud data reception method, and point cloud data reception device according to embodiments may perform encoding and decoding by partitioning the point cloud data in units of tiles and/or slices, and signal necessary data therefor, thereby improving encoding and decoding performance of the point cloud.

The point cloud data transmission method, point cloud data transmission device, point cloud data reception method, and point cloud data reception device according to embodiments may quickly and accurately predict motion of point cloud data captured by LiDAR equipment on a moving vehicle by separating roads and objects in the point cloud data based on an average radius for each laser ID or a calculated radius for each laser ID and generating respective prediction units. Thereby, efficient compression of the geometry of point cloud content captured by the LiDAR equipment on the moving vehicle may be supported.

The point cloud data transmission method, point cloud data transmission device, point cloud data reception method, and point cloud data reception device according to embodiments may reduce the size of a bitstream of geometry information by separating roads and objects in the point cloud data, generating respective prediction units, signaling whether motion compensation is applied per prediction unit. Thereby, a capture/compression/transmission/reconstruction/replay service of real-time point cloud data may be efficiently supported.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings:

FIG. 1 illustrates an exemplary point cloud content providing system according to embodiments.

FIG. 2 is a block diagram illustrating a point cloud content providing operation according to embodiments.

FIG. 3 illustrates an exemplary process of capturing a point cloud video according to embodiments.

FIG. 4 illustrates an exemplary block diagram of point cloud video encoder according to embodiments.

FIG. 5 illustrates an example of voxels in a 3D space according to embodiments.

FIG. 6 illustrates an example of octree and occupancy code according to embodiments.

FIG. 7 illustrates an example of a neighbor node pattern according to embodiments.

FIG. 8 illustrates an example of point configuration of a point cloud content for each LOD according to embodiments.

FIG. 9 illustrates an example of point configuration of a point cloud content for each LOD according to embodiments.

FIG. 10 illustrates an example of a block diagram of a point cloud video decoder according to embodiments.

FIG. 11 illustrates an example of a point cloud video decoder according to embodiments.

FIG. 12 illustrates a configuration for point cloud video encoding of a transmission device according to embodiments.

FIG. 13 illustrates a configuration for point cloud video decoding of a reception device according to embodiments.

FIG. 14 illustrates an exemplary structure operatively connectable with a method/device for transmitting and receiving point cloud data according to embodiments.

FIG. 15 is a diagram illustrating an example of point cloud data acquired using LiDAR equipment according to embodiments.

FIG. 16 is a diagram illustrating an example of points constituting a road captured by LiDAR equipment according to embodiments.

FIG. 17 is a diagram illustrating an example of point cloud data captured by LiDAR equipment according to embodiments.

FIG. 18-(a) is a diagram illustrating example LiDAR equipment according to embodiments.

FIGS. 18-(b) and 18-(c) are diagrams illustrating an example of point cloud data acquired using LiDAR equipment according to embodiments.

FIG. 19 is a diagram illustrating an example of separating objects from point cloud data according to embodiments.

FIG. 20 is a diagram illustrating an example of predicting (or expecting) a radius by a specific laser sensor according to embodiments.

FIG. 21 is a table illustrating an example of calculating an expected radius according to embodiments.

FIG. 22 is a diagram illustrating an example of separating roads from point cloud data composed of roads and objects, leaving only objects, according to embodiments.

FIG. 23 is a diagram illustrating another example of a point cloud transmission device according to embodiments.

FIG. 24 is a diagram illustrating example operations of a geometry encoder and an attribute encoder according to embodiments.

FIG. 25 is a diagram illustrating another example of a point cloud reception device according to embodiments.

FIG. 26 is a diagram illustrating example operations of a geometry decoder and an attribute decoder according to embodiments.

FIG. 27 illustrates an example bitstream structure of point cloud data for transmission/reception according to embodiments.

FIG. 28 illustrates another example bitstream structure of point cloud data for transmission/reception according to embodiments.

FIG. 29 is a diagram illustrating an example syntax structure of a sequence parameter set according to embodiments.

FIG. 30 is a diagram illustrating an example syntax structure of a geometry parameter set according to embodiments.

FIG. 31 is a diagram illustrating an example syntax structure of a tile parameter set according to embodiments.

FIG. 32 is a diagram illustrating an example syntax structure of a geometry slice header according to embodiments.

FIG. 33 is a diagram illustrating an example syntax structure of a geometry LPU header according to embodiments.

FIG. 34 is a diagram illustrating an example syntax structure of a geometry PU header according to embodiments.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. It should be noted that the following examples are only for embodying the present disclosure and do not limit the scope of the present disclosure. What can be easily inferred by an expert in the technical field to which the present disclosure belongs from the detailed description and examples of the present disclosure is to be interpreted as being within the scope of the present disclosure.

The detailed description in this present specification should be construed in all aspects as illustrative and not restrictive. The scope of the disclosure should be determined by the appended claims and their legal equivalents, and all changes coming within the meaning and equivalency range of the appended claims are intended to be embraced therein.

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that can be implemented according to the present disclosure. The following detailed description includes specific details in order to provide a thorough understanding of the present disclosure. However, it will be apparent to those skilled in the art that the present disclosure may be practiced without such specific details. Although most terms used in this specification have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings. In addition, the following drawings and detailed description should not be construed as being limited to the specifically described embodiments, but should be construed as including equivalents or substitutes of the embodiments described in the drawings and detailed description.

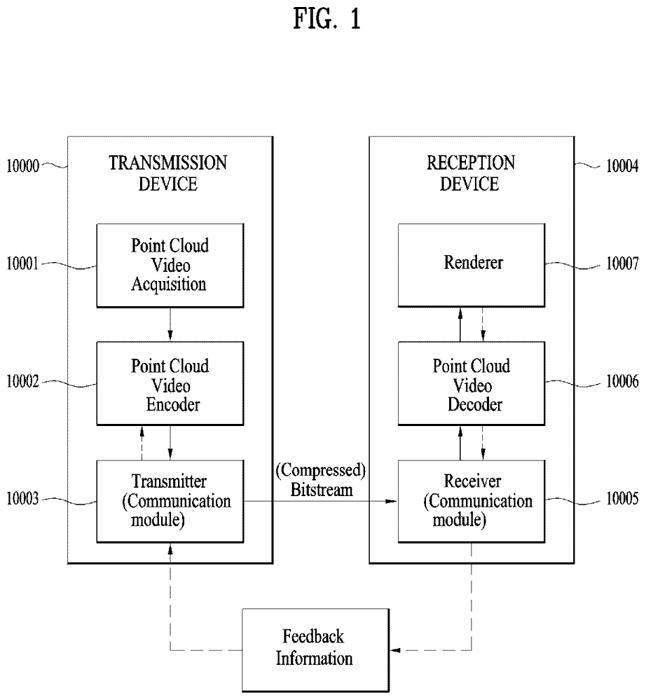

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquisition unit 10001, a point cloud video encoder 10002, and/or a transmitter (or communication module) 10003.

The point cloud video acquisition unit 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (e.g., a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (e.g., a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component or module) separate from the receiver 10005.

The point cloud video decoder 10006 decodes the bitstream containing the point cloud video data. The point cloud video decoder 10006 may decode the point cloud video data according to the method by which the point cloud video data is encoded (e.g., in a reverse process of the operation of the point cloud video encoder 10002). Accordingly, the point cloud video decoder 10006 may decode the point cloud video data by performing point cloud decompression coding, which is the reverse process to the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like).

The dotted lines in FIG. 1 represent a process of transmitting the feedback information secured by the renderer 10007. The point cloud content providing system may process (encode/decode) point cloud data based on the feedback information. Accordingly, the point cloud video decoder 10006 may perform a decoding operation based on the feedback information. The reception device 10004 may transmit the feedback information to the transmission device 10000. The transmission device 10000 (or the point cloud video encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmitting device, a transmitter, a transmission system, or the like, and the reception device 10004 may be called a decoder, a receiving device, a receiver, a reception system, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

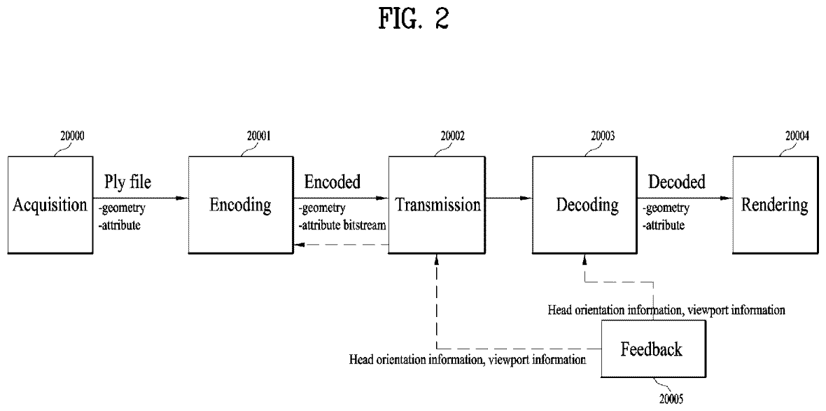

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (e.g., the point cloud transmission device 10000 or the point cloud video acquisition unit 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (e.g., values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance.

According to embodiments, the geometry may be called positions, geometry information, geometry data, or the like, and the attribute may be called attributes, attribute information, attribute data, or the like.

The point cloud content providing system (e.g., the point cloud transmission device 10000 or the point cloud video acquisition unit 10001) may secure point cloud data from information (e.g., depth information, color information, etc.) related to the acquisition process of the point cloud video.

The point cloud content providing system (e.g., the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (e.g., the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (e.g., signaling information related to the geometry encoding and the attribute encoding). The point cloud content providing system may encapsulate a bitstream that carries the encoded point cloud data and transmit the same in the form of a file or segment.

The point cloud content providing system (e.g., the reception device 10004 or the receiver 10005) according to the embodiments may receive the bitstream containing the encoded point cloud data. In addition, the point cloud content providing system (e.g., the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (e.g., the reception device 10004 or the point cloud video decoder 10005) may decode the point cloud video data based on the signaling information related to encoding of the point cloud video data contained in the bitstream. The point cloud content providing system (e.g., the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (e.g., the reception device 10004 or the point cloud video decoder 10005) may reconstruct the point cloud video based on the positions according to the reconstructed geometry and the decoded attributes.

The point cloud content providing system according to the embodiments (e.g., the reception device 10004 or the renderer 10007) may render the decoded point cloud data (20004). The point cloud content providing system (e.g., the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

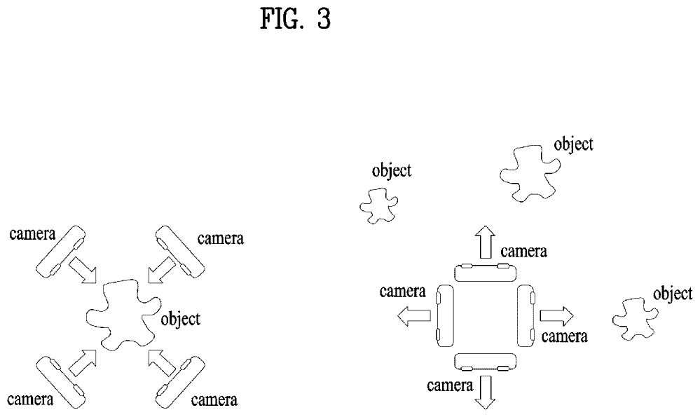

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in FIG. 3, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (e.g., a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

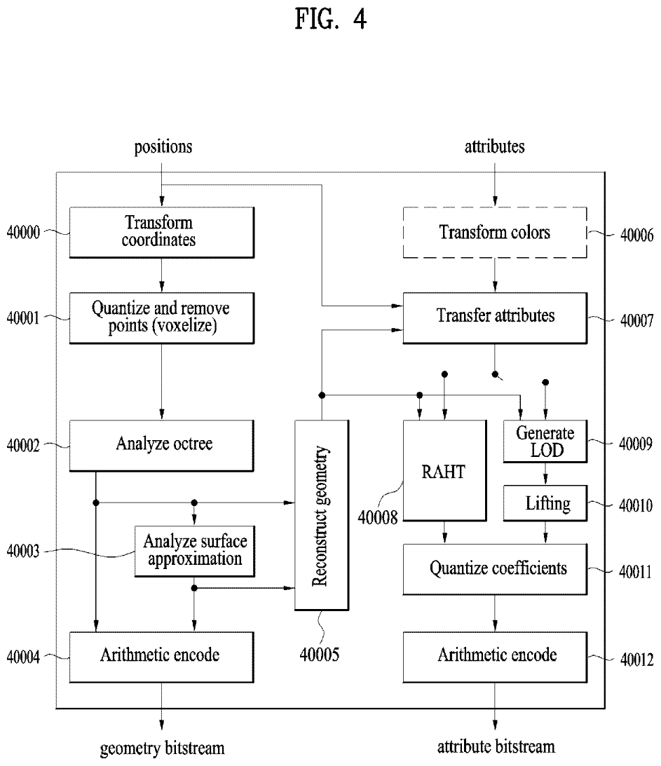

FIG. 4 illustrates an exemplary point cloud video encoder according to embodiments.

FIG. 4 shows an example of the point cloud video encoder 10002 of FIG. 1.

The point cloud video encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 to 2, the point cloud video encoder may perform geometry encoding and attribute encoding. The geometry encoding is performed before the attribute encoding.

The point cloud video encoder according to the embodiments includes a coordinate transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometry reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate transformer 40000 according to the embodiments receives positions and transforms the same into coordinates. For example, the positions may be transformed into position information in a three-dimensional space (e.g., a three-dimensional space represented by an XYZ coordinate system). The position information in the three-dimensional space according to the embodiments may be referred to as geometry information.

The quantizer 40001 according to the embodiments quantizes the geometry information. For example, the quantizer 40001 may quantize the points based on a minimum position value of all points (e.g., a minimum value on each of the X, Y, and Z axes). The quantizer 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 40001 according to the embodiments performs voxelization based on the quantized positions to reconstruct quantized points. The voxelization means a minimum unit representing position information in 3D space. Points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center point of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (for example, from RGB to YCbCr). The operation of the color transformer 40006 according to embodiments may be optionally applied according to the color values included in the attributes.

The geometry reconstructor 40005 according to the embodiments reconstructs (decompresses) the octree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) can be performed quickly. The Morton code is generated by presenting coordinates (e.g., (x, y, z)) representing 3D positions of all points as bit values and mixing the bits. For example, when the coordinates representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD). The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud video encoder of FIG. 4 may be implemented by hardware including one or more processors or integrated circuits configured to communicate with one or more memories included in the point cloud content providing apparatus, software, firmware, or a combination thereof. The one or more processors may perform at least one of the operations and/or functions of the elements of the point cloud video encoder of FIG. 4 described above. Additionally, the one or more processors may operate or execute a set of software programs and/or instructions for performing the operations and/or functions of the elements of the point cloud video encoder of FIG. 4. The one or more memories according to the embodiments may include a high speed random access memory, or include a non-volatile memory (e.g., one or more magnetic disk storage devices, flash memory devices, or other non-volatile solid-state memory devices).

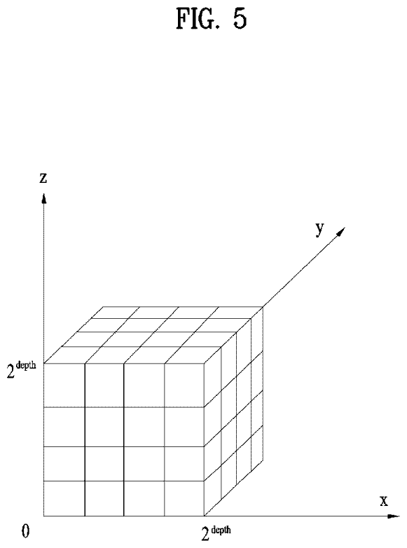

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud video encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (24, 24, 24) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

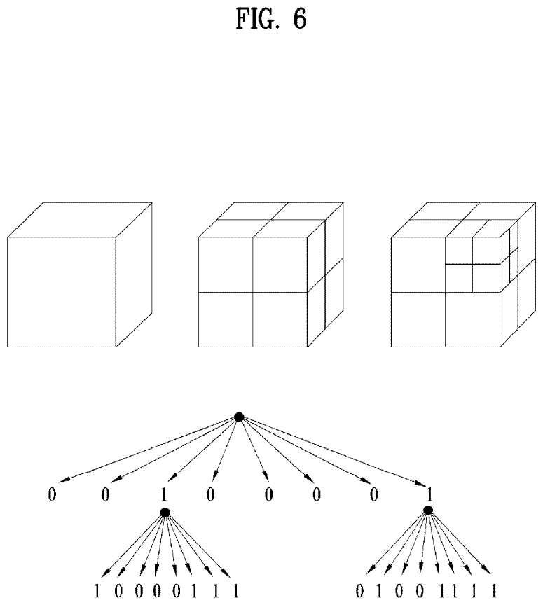

FIG. 6 shows an example of an octree and occupancy code according to embodiments.

As described with reference to FIGS. 1 to 4, the point cloud content providing system (point cloud video encoder 10002) or the octree analyzer 40002 of the point cloud video encoder performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}). Here, 2^{d} may be set to a value constituting the smallest bounding box surrounding all points of the point cloud content (or point cloud video). Here, d denotes the depth of the octree. The value of d is determined in Equation 1. In Equation 1, (x^{int}ₙ, y^{int}ₙ, z^{int}ₙ) denotes the positions (or position values) of quantized points.

$$d = Ceil ( Log 2 ( Max ( {x}_{n}^{int} , {y}_{n}^{int} , {z}_{n}^{int} , n = 1 , … , N ) + 1 ) ) \qquad Equation 1$$

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0). Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud video encoder (e.g., the arithmetic encoder 40004) according to the embodiments may perform entropy encoding on the occupancy codes. In order to increase the compression efficiency, the point cloud video encoder may perform intra/inter-coding on the occupancy codes. The reception device (e.g., the reception device 10004 or the point cloud video decoder 10006) according to the embodiments reconstructs the octree based on the occupancy codes.

The point cloud video encoder (e.g., the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud video encoder according to the embodiments may skip voxelization and perform direct coding to directly code the positions of points included in the specific region. The coordinates of a direct coding point according to the embodiments are referred to as direct coding mode (DCM). The point cloud video encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud video decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud video encoder (or the arithmetic encoder 40004) according to the embodiments may perform entropy coding on the positions (or position values) of the points.

The point cloud video encoder (e.g., the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud video encoder according to the embodiments may specify a level at which trisoup geometry encoding is to be applied. For example, when the specific level is equal to the depth of the octree, the point cloud video encoder does not operate in the trisoup mode. In other words, the point cloud video encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud video encoder according to the embodiments may perform entropy encoding on the starting point (x, y. 2) of the edge, the direction vector (Δx, Δy, Δz) of the edge, and the vertex position value (relative position value within the edge). When the trisoup geometry encoding is applied, the point cloud video encoder according to the embodiments (e.g., the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed according to Equation 2 by: i) calculating the centroid value of each vertex, ii) subtracting the center value from each vertex value, and iii) estimating the sum of the squares of the values obtained by the subtraction.

$$[ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ] \qquad Equation 2$$

Then, the minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of 0 is estimated through a tan2(bi, ai), and the vertices are ordered based on the value of 0. The table 1 below shows a combination of vertices for creating a triangle according to the number of the vertices. The vertices are ordered from 1 to n. The table 1 below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

[Table 1] Triangles formed from vertices ordered 1, . . . , n

TABLE 1

| n | Triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), (5, 7, 9), |
| | (9, 1, 5) |
| 11 | (1, 2, 3), (3, 4, 5), (5, 6, 7), (7, 8, 9), (9, 10, 11), (11, 1, 3), (3, 5, 7), |
| | (7, 9, 11), (11, 3, 7) |
| 12 | (1, 2, 3), (3, 4, 5), (5, 6, 7), (7, 8, 9), (9, 10, 11), (11, 12, 1), (1, 3, |
| | 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud video encoder according to the embodiments may voxelize the refined vertices. In addition, the point cloud video encoder may perform attribute encoding based on the voxelized positions (or position values).

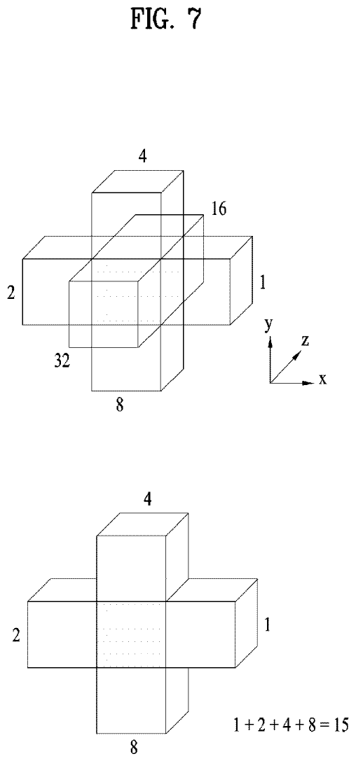

FIG. 7 shows an example of a neighbor node pattern according to embodiments.

In order to increase the compression efficiency of the point cloud video, the point cloud video encoder according to the embodiments may perform entropy coding based on context adaptive arithmetic coding.

As described with reference to FIGS. 1 to 6, the point cloud content providing system or the point cloud video encoder 10002 of FIG. 1, or the point cloud video encoder or arithmetic encoder 40004 of FIG. 4 may perform entropy coding on the occupancy code immediately. In addition, the point cloud content providing system or the point cloud video encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 2³=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud video encoder according to the embodiments determines occupancy of neighbor nodes of each node of the octree and obtains a value of a neighbor pattern. The neighbor node pattern is used to infer the occupancy pattern of the node. The upper part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The lower part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud video encoder may perform coding according to the neighbor node pattern value (for example, when the neighbor node pattern value is 63, 64 kinds of coding may be performed). According to embodiments, the point cloud video encoder may reduce coding complexity by changing a neighbor node pattern value (for example, based on a table by which 64 is changed to 10 or 6).

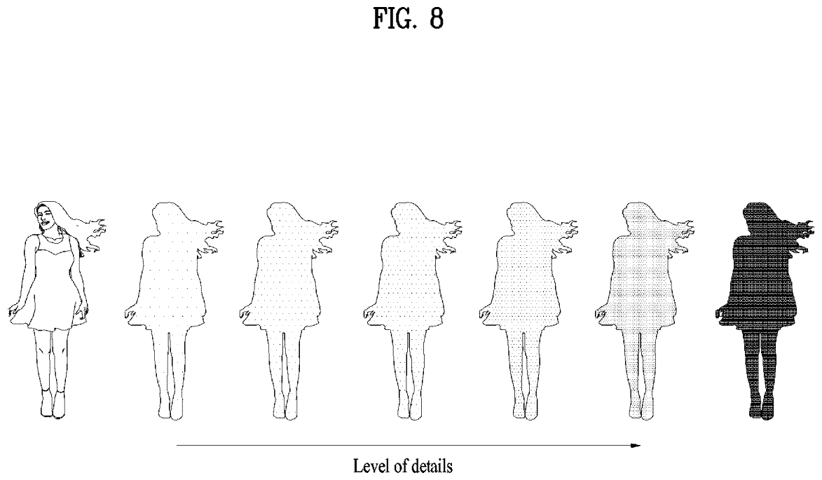

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud video encoder (e.g., the LOD generator 40009) may classify (reorganize or group) points by LOD. FIG. 8 shows the point cloud content corresponding to LODs. The leftmost picture in FIG. 8 represents original point cloud content. The second picture from the left of FIG. 8 represents distribution of the points in the lowest LOD, and the rightmost picture in FIG. 8 represents distribution of the points in the highest LOD. That is, the points in the lowest LOD are sparsely distributed, and the points in the highest LOD are densely distributed. That is, as the LOD rises in the direction pointed by the arrow indicated at the bottom of FIG. 8, the space (or distance) between points is narrowed.

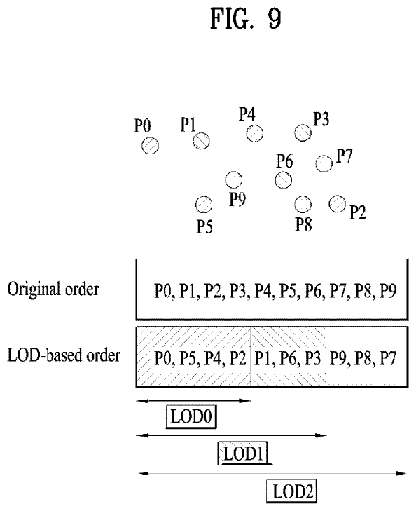

FIG. 9 illustrates an example of point configuration for each LOD according to embodiments.

As described with reference to FIGS. 1 to 8, the point cloud content providing system, or the point cloud video encoder (e.g., the point cloud video encoder 10002 of FIG. 1, the point cloud video encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud video encoder, but also by the point cloud video decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud video encoder according to the embodiments may perform prediction transform coding based on LOD, lifting transform coding based on LOD, and RAHT transform coding selectively or in combination.

The point cloud video encoder according to the embodiments may generate a predictor for points to perform prediction transform coding based on LOD for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud video encoder according to the embodiments (e.g., the coefficient quantizer 40011) may quantize and inversely quantize the residual of each point (which may be called residual attribute, residual attribute value, attribute prediction residual value or prediction error attribute value and so on) obtained by subtracting a predicted attribute (or attribute value) each point from the attribute (i.e., original attribute value) of each point. The quantization process performed for a residual attribute value in a transmission device is configured as shown in table 2. The inverse quantization process performed for a residual attribute value in a reception device is configured as shown in table 3.

TABLE 2

int PCCQuantization(int value, int quantStep) {
if( value >=0) {
return floor(value / quantStep + 1.0 / 3.0);
} else {
return -floor(-value / quantStep + 1.0 / 3.0);
}
}

TABLE 3

int PCCInverseQuantization(int value, int quantStep) {
if( quantStep ==0) {
return value;
} else {
return value * quantStep;
}
}

When the predictor of each point has neighbor points, the point cloud video encoder (e.g., the arithmetic encoder 40012) according to the embodiments may perform entropy coding on the quantized and inversely quantized residual attribute values as described above. When the predictor of each point has no neighbor point, the point cloud video encoder according to the embodiments (e.g., the arithmetic encoder 40012) may perform entropy coding on the attributes of the corresponding point without performing the above-described operation. The point cloud video encoder according to the embodiments (e.g., the lifting transformer 40010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows. 1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud video encoder (e.g., coefficient quantizer 40011) according to the embodiments quantizes the predicted attribute values. In addition, the point cloud video encoder (e.g., the arithmetic encoder 40012) performs entropy coding on the quantized attribute values.

The point cloud video encoder (e.g., the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud video encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

Equation 3 below represents a RAHT transformation matrix. In Equation 3, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$⌈ \begin{matrix}{g}_{l - {1}_{x , y , z}} \\ {h}_{l - {1}_{x , y , z}}\end{matrix} ⌉ = {T}_{w 1 w 2} ⌈ \begin{matrix}{g}_{{l}_{2 x , y , z}} \\ {h}_{{l}_{2 x + 1 , y , z}}\end{matrix} ⌉ {T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ] \qquad Equation 3$$

Here, gₗ₋₁_{_{x,y,z}} is a low-pass value and is used in the merging process at the next higher level. hₗ₋₁_{_{x,y,z}} denotes high-pass coefficients. The high-pass coefficients at each step are quantized and subjected to entropy coding (e.g., encoding by the arithmetic encoder 40012). The weights are calculated as w_{l-1x,y,z}=wₗ_{_{2x,y,z}}+wₗ_{_{2x+1,y,z}}. The root node is created through the g₁_{_{0,0,0}} and g₁_{_{0,0,1}} as Equation 4.

$$⌈ \begin{matrix}gDC \\ {h}_{{0}_{0 , 0 , 0}}\end{matrix} ⌉ = {T}_{w 1000 w 1001} ⌈ \begin{matrix}{g}_{{1}_{0 , 0 , 0 z}} \\ {g}_{{1}_{0 , 0 , 0}}\end{matrix} ⌉ \qquad Equation 4$$

The value of gDC is also quantized and subjected to entropy coding like the high-pass coefficients.

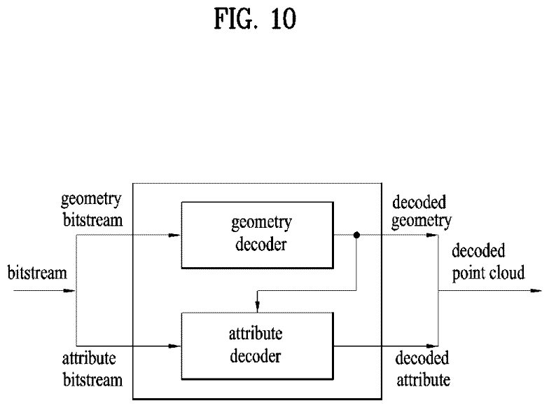

FIG. 10 illustrates a point cloud video decoder according to embodiments.

The point cloud video decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud video decoder may receive a geometry bitstream and an attribute bitstream contained in one or more bitstreams. The point cloud video decoder includes a geometry decoder and an attribute decoder. The geometry decoder performs geometry decoding on the geometry bitstream and outputs decoded geometry. The attribute decoder performs attribute decoding on the attribute bitstream based on the decoded geometry, and outputs decoded attributes. The decoded geometry and decoded attributes are used to reconstruct point cloud content (a decoded point cloud).

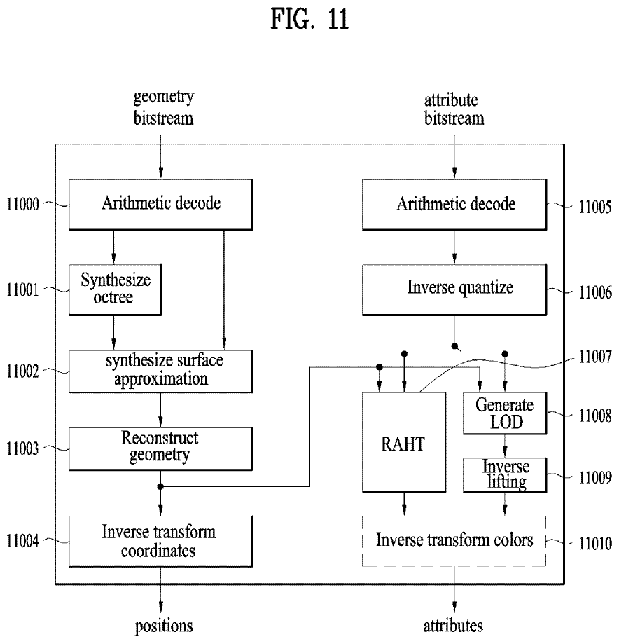

FIG. 11 illustrates a point cloud video decoder according to embodiments.

The point cloud video decoder illustrated in FIG. 11 is an example of the point cloud video decoder illustrated in FIG. 10, and may perform a decoding operation, which is a reverse process to the encoding operation of the point cloud video encoder illustrated in FIGS. 1 to 9.

As described with reference to FIGS. 1 and 10, the point cloud video decoder may perform geometry decoding and attribute decoding. The geometry decoding is performed before the attribute decoding.

The point cloud video decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct decoding and trisoup geometry decoding. The direct decoding and trisoup geometry decoding are selectively applied. The geometry decoding is not limited to the above-described example, and is performed as a reverse process to the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the reverse process to the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied. Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud video encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud video encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud video encoder.

Although not shown in the figure, the elements of the point cloud video decoder of FIG. 11 may be implemented by hardware including one or more processors or integrated circuits configured to communicate with one or more memories included in the point cloud content providing apparatus, software, firmware, or a combination thereof. The one or more processors may perform at least one or more of the operations and/or functions of the elements of the point cloud video decoder of FIG. 11 described above. Additionally, the one or more processors may operate or execute a set of software programs and/or instructions for performing the operations and/or functions of the elements of the point cloud video decoder of FIG. 11.

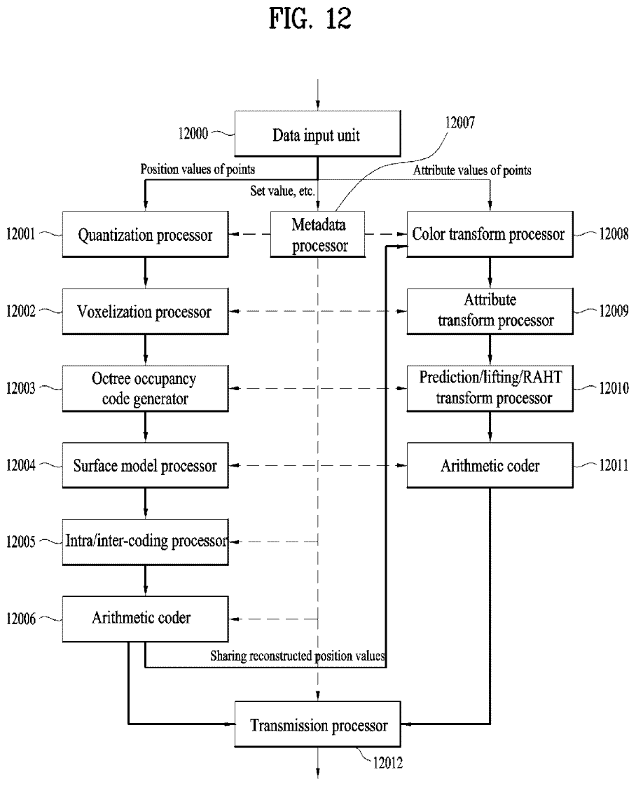

FIG. 12 illustrates a transmission device according to embodiments.

The transmission device shown in FIG. 12 is an example of the transmission device 10000 of FIG. 1 (or the point cloud video encoder of FIG. 4). The transmission device illustrated in FIG. 12 may perform one or more of the operations and methods the same as or similar to those of the point cloud video encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquisition unit 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantizer 40001 described with reference to FIG. 4. Details are the same as those described with reference to FIGS. 1 to 9.

The voxelization processor 12002 according to the embodiments voxelizes the quantized position values of the points. The voxelization processor 12002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud video encoder (or the octree analyzer 40002) described with reference to FIGS. 4 and 6. Details are the same as those described with reference to FIGS. 1 to 9.

The surface model processor 12004 according to the embodiments may perform trisoup geometry encoding based on a surface model to reconstruct the positions of points in a specific region (or node) on a voxel basis. The surface model processor 12004 may perform an operation and/or method the same as or similar to the operation and/or method of the point cloud video encoder (e.g., the surface approximation analyzer 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformer 40006 described with reference to FIG. 4 is performed. The detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformer 40007 described with reference to FIG. 4. A detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same as or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same as or similar to the operation and/or method of the arithmetic encoder 40012.

The transmission processor 12012 according to the embodiments may transmit each bitstream containing encoded geometry and/or encoded attributes and metadata, or transmit one bitstream configured with the encoded geometry and/or the encoded attributes and the metadata. When the encoded geometry and/or the encoded attributes and the metadata according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS or tile inventory) for signaling of a tile level, and slice data. The slice data may include information about one or more slices. One slice according to embodiments may include one geometry bitstream Geom0⁰ and one or more attribute bitstreams Attr0⁰ and Attr1⁰.

A slice refers to a series of syntax elements representing the entirety or part of a coded point cloud frame.

The TPS according to the embodiments may include information about each tile (e.g., coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload. As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same as or similar to the operation and/or transmission method of the transmitter 10003. Details are the same as those described with reference to FIGS. 1 and 2, and thus a description thereof is omitted.

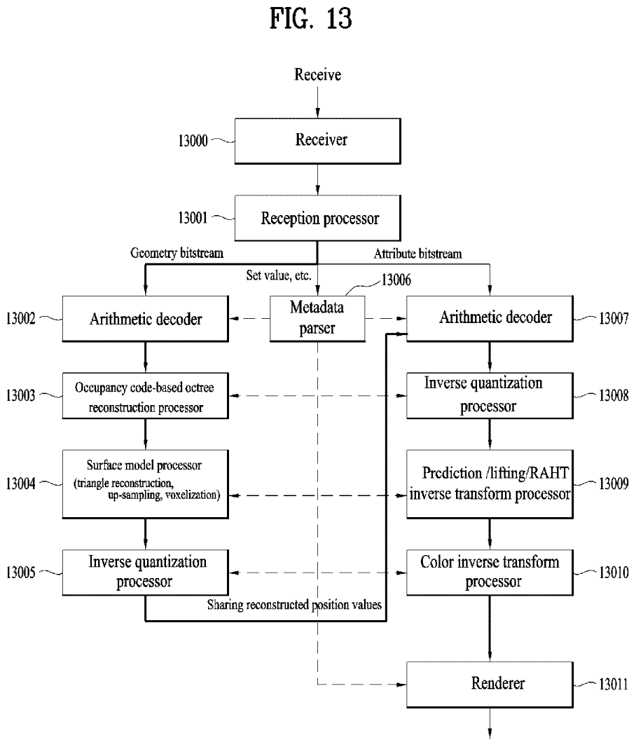

FIG. 13 illustrates a reception device according to embodiments.

The reception device illustrated in FIG. 13 is an example of the reception device 10004 of FIG. 1 (or the point cloud video decoder of FIGS. 10 and 11). The reception device illustrated in FIG. 13 may perform one or more of the operations and methods the same as or similar to those of the point cloud video decoder described with reference to FIGS. 1 to 11.

The reception device according to the embodiment includes a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform a reverse process to the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. The detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 13005 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 13004 according to the embodiments may perform trisoup geometry decoding and related geometry reconstruction (e.g., triangle reconstruction, up-sampling, voxelization) based on the surface model method. The surface model processor 13004 performs an operation the same as or similar to that of the surface approximation synthesizer 11002 and/or the geometry reconstructor 11003.

The inverse quantization processor 13005 according to the embodiments may inversely quantize the decoded geometry.

The metadata parser 13006 according to the embodiments may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same as or similar to the operation and/or inverse quantization method of the inverse quantizer 11006.

The prediction/lifting/RAHT inverse transform processor 13009 according to the embodiments may process the reconstructed geometry and the inversely quantized attributes. The prediction/lifting/RAHT inverse transform processor 13009 performs one or more of operations and/or decoding the same as or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 according to the embodiments may render the point cloud data.

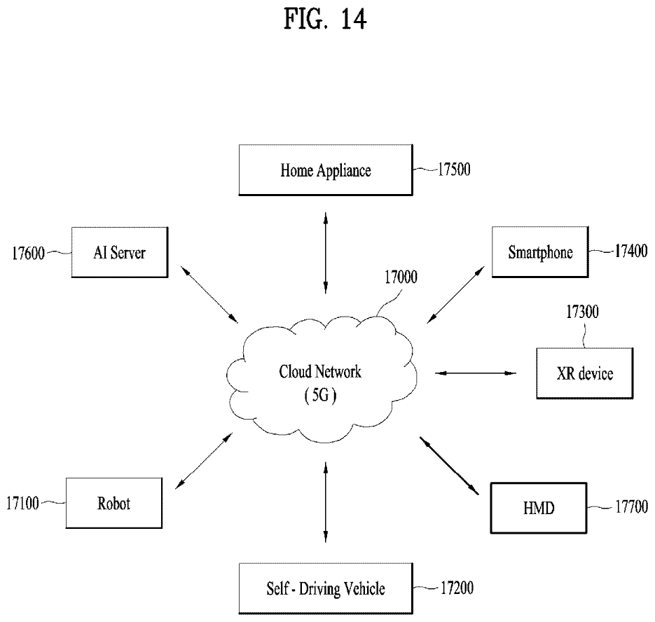

FIG. 14 shows an exemplary structure operatively connectable with a method/device for transmitting and receiving point cloud data according to embodiments.

The structure of FIG. 14 represents a configuration in which at least one of a server 17600, a robot 17100, a self-driving vehicle 17200, an XR device 17300, a smartphone 17400, a home appliance 17500, and/or a head-mount display (HMD) 17700 is connected to a cloud network 17100. The robot 17100, the self-driving vehicle 17200, the XR device 17300, the smartphone 17400, or the home appliance 17500 is referred to as a device. In addition, the XR device 17300 may correspond to a point cloud compressed data (PCC) device according to embodiments or may be operatively connected to the PCC device.

The cloud network 17000 may represent a network that constitutes part of the cloud computing infrastructure or is present in the cloud computing infrastructure. Here, the cloud network 17000 may be configured using a 3G network, 4G or Long Term Evolution (LTE) network, or a 5G network.

The server 17600 may be connected to at least one of the robot 17100, the self-driving vehicle 17200, the XR device 17300, the smartphone 17400, the home appliance 17500, and/or the HMD 17700 over the cloud network 17000 and may assist in at least a part of the processing of the connected devices 17100 to 17700.

The HMD 17700 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 17100 to 17500 to which the above-described technology is applied will be described. The devices 17100 to 17500 illustrated in FIG. 14 may be operatively connected/coupled to a point cloud data transmission device and reception device according to the above-described embodiments.

### <PCC+XR>

The XR/PCC device 17300 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 17300 may analyze 3D point cloud data or image data acquired through various sensors or from an external device and generate position data and attribute data about 3D points. Thereby, the XR/PCC device 17300 may acquire information about the surrounding space or a real object, and render and output an XR object. For example, the XR/PCC device 17300 may match an XR object including auxiliary information about a recognized object with the recognized object and output the matched XR object.

### <PCC+Self-Driving+XR>

The self-driving vehicle 17200 may be implemented as a mobile robot, a vehicle, an unmanned aerial vehicle, or the like by applying the PCC technology and the XR technology.

The self-driving vehicle 17200 to which the XR/PCC technology is applied may represent a self-driving vehicle provided with means for providing an XR image, or a self-driving vehicle that is a target of control/interaction in the XR image. In particular, the self-driving vehicle 17200 which is a target of control/interaction in the XR image may be distinguished from the XR device 17300 and may be operatively connected thereto.

The self-driving vehicle 17200 having means for providing an XR/PCC image may acquire sensor information from sensors including a camera, and output the generated XR/PCC image based on the acquired sensor information. For example, the self-driving vehicle 17200 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen. For example, the self-driving vehicle 17200 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC. V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud compression data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described above, the point cloud content providing system may use one or more cameras (e.g., an infrared camera capable of securing depth information, an RGB camera capable of extracting color information corresponding to the depth information, etc.), a projector (e.g., an infrared pattern projector configured to secure depth information, etc.), LiDAR, and the like to generate point cloud content (or point cloud data).

LiDAR refers to equipment configured to measure the distance by measuring the time it takes for the irradiated light to reflect off a subject and return. It provides precise three-dimensional information about the real world as point cloud data over a wide area and long distance. Such large-volume point cloud data may be widely used in various fields where computer vision technology is employed, such as autonomous vehicles, robots, and 3D map production. That is, the LiDAR equipment uses a radar system configured to measure the coordinates of a position of a reflector by emitting a laser pulse and measuring the time it takes for the laser pulse to reflect on a subject (i.e., a reflector) in order to generate point cloud content. According to embodiments, the depth information may be extracted through the LiDAR equipment. The point cloud content generated through the LiDAR equipment may be composed of multiple frames, and the multiple frames may be integrated into one piece of content.

The LiDAR may consist of N lasers (or laser sensors) (where N=16, 32, 64, etc.) at different elevations θ(i)_{i=1, . . . , N}, and the lasers may capture point cloud data while spinning along an azimuth φ with respect to the Y axis. This type of LiDAR model is referred to as a spinning LiDAR model, and the point cloud content captured and generated by the spinning LiDAR model has angular characteristics.

The acquired (or captured) point cloud (or point cloud data) may be composed of a set of points, each of which may have geometry information and attribute information. As described above, the geometry information is 3D position (XYZ) information, and the attribute information is a color (RGB, YUV, etc.) and/or reflectance value.

According to embodiments, for data captured by spinning LiDAR equipment, compression efficiency may be increased by applying an angular mode in the geometry encoding/decoding process. The angular mode is a compression method based on (r, φ, i) instead of (x, y, z), where r denotes the radius, φ denotes the azimuth or azimuthal angle, and i denotes the i-th laser (e.g., laser index) of the LiDAR. In other words, since the frames of the point cloud content generated using the LiDAR equipment are not stitched together, but are individual frames, each of which may have an origin of 0, 0, 0, the angular mode may be used by changing to the coordinate system to a spherical coordinate system.

During G-PCC encoding according to embodiments, the point cloud data may be split into tiles according to regions, and each tile may be split into slices for parallel processing. The G-PCC encoding may include compressing the geometry on a slice-by-slice basis, and compressing the attribute information based on the reconstructed geometry (decoded geometry) obtained based on the position information changed by the compression. An octree-based, predictive tree-based, or trisoup-based compression method may be used to compress the geometry information.

G-PCC decoding according to embodiments may include decoding the slice-wise geometry encoded and transmitted by the transmission device, and decoding the attribute information based on the geometry reconstructed through the decoding operation.

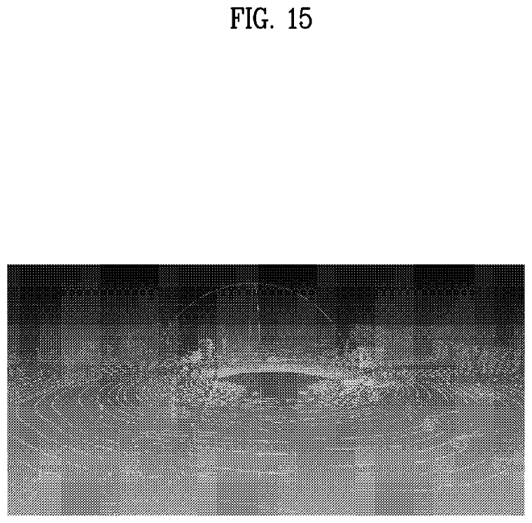

FIG. 15 is a diagram illustrating an example of point cloud data acquired using LiDAR equipment according to embodiments.

As shown in FIG. 15, point cloud content captured by LiDAR equipment on a moving vehicle may include both roads and objects. In other words, a street may include not only roads, but also many objects, such as trees, buildings, cars, and people. In the present disclosure, point cloud content may be referred to as point cloud data or a point cloud. There may be one or more objects. A plurality of objects may be referred to simply as objects or as an object group or an object block.

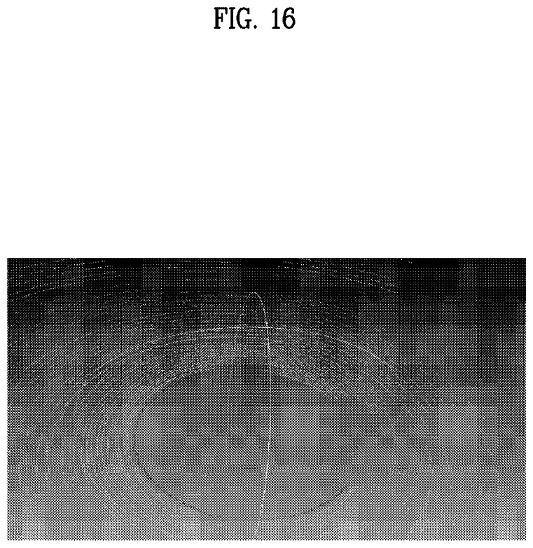

When a point cloud is configured capturing consecutive frames, the characteristics of motion presented in the consecutive frames of points constituting a road may differ from the characteristics of motion presented in the consecutive frames of points constituting an object (or objects). In particular, in the case of a road captured by LiDAR capture equipment (or LiDAR equipment), the relative height from the LiDAR capture equipment may be constant. In this case, points may be generated in a shape of a circle around a center point, which is the location of the sensor, as shown in FIG. 16.

FIG. 16 is a diagram illustrating an example of points constituting a road captured by LiDAR equipment according to embodiments.

According to embodiments, when there are no objects and only the road in point cloud frames captured by LiDAR equipment on a moving vehicle or when the relative heights of the road and the center position of the sensor are constant, frames are always captured in the shape shown in FIG. 16. For this reason, it is difficult to recognize the motion represented by the road points across consecutive frames. Furthermore, applying the motion generated from an object to the road may not be meaningful, and may have an adverse effect, increasing bitstream size and thus lowering compression efficiency. Conversely, applying a motion predicted from the road to an object may lead to inaccurate motion prediction because the predicted motion is unlikely to be accurate.

Therefore, a method for separating (or distinguishing or classifying) the road and the object(s) from the point cloud content continuously captured by LiDAR equipment on a moving vehicle may be needed.

The present disclosure describes embodiments of methods for separating a road and object from point cloud content to efficiently support compression of point cloud content captured by LiDAR equipment on a moving vehicle. The object may include one or more objects.

In particular, the present disclosure describes embodiments of methods for separating a road and an object from point cloud content to efficiently support inter-prediction of point cloud content captured by LiDAR equipment on a moving vehicle.

The present disclosure describes embodiments of methods for separating a road and an object from point cloud content based on characteristics of the LiDAR equipment. For LiDAR equipment such as spinning LiDAR, input information about the number of laser sensors in the LiDAR equipment, the angle of each laser sensor, the height, etc. is provided. Roads and objects in the point cloud content are separated based on the input information.

According to embodiments, the separation of roads and objects in the point cloud content (i.e., point cloud data) may be performed by an encoder on the transmitting side or by a decoder on the receiving side. For example, in the case where the separation of roads and objects in the point cloud data is performed by the encoder on the transmitting side, this separation may be omitted on the receiving side. Conversely, in the case where the separation of roads and objects in the point cloud data is performed by the decoder on the receiving side, the separation may be omitted on the transmitting side. According to embodiments, whether the separation of roads and objects from the point cloud data is to be performed by the encoder on the transmitting side or by the decoder on the receiving side may be indicated using signaling information, or may be determined based on signaling information.

According to embodiments, the segmentation of roads and objects may be performed by an encoder on the transmitting side and the reconstruction operation may be performed differently for each of the road and object in the decoding process by a decoder on the receiving side.

According to embodiments, it is assumed that the LiDAR equipment has a plurality of laser sensors, and that the laser ID of the laser sensor closest to the road has the least value, and that the laser ID and the radius of a captured road may increase as the distance from the road (i.e., the altitude) increases. In other words, for content captured by the LiDAR equipment on a moving vehicle, a road having a larger radius may be captured by a greater laser ID (i.e., a higher laser sensor).

In the case where only a road has been captured by the LiDAR equipment, the radius of the points at the current laserID should be larger than the average radius at the previous laserID. If the radius of the points at the current laserID is smaller than the average radius at the previous laserID, that is, the distance is smaller than the average radius at the previous laserID (smaller than the expected distance), an object is present in the middle. This is because if an object is present in the middle, the radius may be reduced and the altitude may be increased. According to embodiments, a method of separating the road and the object may be carried out based on an average radius for each laser ID (laserID). Here, the laserID is identification information for identifying each laser (or laser sensor) in the LiDAR equipment, and may refer to a laser index.

According to embodiments, if the radius of the point(s) captured at the current laserID is smaller than the average radius at the previous laserID, i.e., the distance is smaller than the average radius (i.e., the expected distance) at the previous laserID, or if the radius is outside a specific range at successive azimuths at the same laserID (or the z value is outside a specific range), the point(s) is classified as an object. Otherwise, the point(s) is classified as a road. Here, the object may be one or more objects, which may be referred to as an object group. The radius outside the specific range at consecutive azimuths at the same laserID means that the radius of the captured point(s) is smaller than the average radius and is outside the specific range.

According to embodiments, another method of separating the road and the object may be carried out may be carried out based on an expected radius for each laserID. Here, laserID is identification information for identifying each laser (or laser sensor) in the LiDAR equipment, and may refer to a laser index.

According to embodiments, if the radius of the point(s) captured at the current laserID is smaller than an expected average radius at the previous laserID, i.e., the distance is smaller than the expected radius (i.e., the expected distance) at the previous laserID, or if the radius is outside a specific range at successive azimuths at the same laserID (or the z value is outside a specific range), the point(s) is classified as an object. Otherwise, the point(s) is classified as a road. Here, the object may be one or more objects, which may be referred to as an object group. The radius outside the specific range at consecutive azimuths at the same laserID means that the radius of the captured point(s) is smaller than the expected radius and is outside the specific range.

According to embodiments, when the road and object are separated from the point cloud data, a prediction unit may be constructed from points separated as the road, and a prediction unit may be constructed from points separated as the object (or object group). Then, inter- or intra-prediction may be performed on each prediction unit. The present disclosure describes inter-prediction as an embodiment. Here, the prediction unit may be a largest prediction unit (LPU) and/or a prediction unit (PU). For simplicity; the LPU may be referred to as a first prediction unit and the PU as a second prediction unit.

According to embodiments, when the road and object are separated in the point cloud data, a first prediction unit may be constructed from points separated as the road, and a first prediction unit may be constructed from points separated as the object (or object group). Then, inter- or intra-prediction may be performed on each of the first prediction units.

According to embodiments, the first prediction unit constructed from the points of the object(s) may be further split into second prediction units. In other words, the first prediction unit composed of multiple objects may be split into second prediction units when the objects have different characteristics.

According to embodiments, global motion may be applied to the first prediction unit for inter-prediction, and local motion may be applied to the second prediction units for inter-prediction.

According to embodiments, global motion may be applied to the first prediction unit composed of the object(s) and no global motion may be applied to the first prediction unit composed of the road.

Regarding inter prediction according to embodiments, definitions of the following terms will be described in the present disclosure.

1) I (Intra) frame: P (Predicted) frame: B (Bidirectional) frame.

A frame to be encoded/decoded may be divided into an I frame, a P frame, and a B frame. The frame may be referred to as a picture or the like.

For example, the frames may be transmitted in order of I frame→P frame→(B frame)→(I frame|P frame)→ . . . . The B frame may be omitted.

### 2) Reference Frame

A reference frame may be a frame involved in encoding/decoding a current frame.

The immediately preceding I frame or P frame referred to for encoding/decoding of the current P frame may be referred to as a reference frame. A immediately preceding I frame or P frame and an immediately following I frame or P frame referred to for encoding/decoding of the current B frame may be referred to as reference frames.

### 3) Frame and Intra Prediction Coding/Inter Prediction Coding

Intra-prediction coding may be performed on the I frame, and inter-prediction coding may be performed on the P frame and the B frame.

When the rate of change of a P frame with respect to the previous reference frame is greater than a specific threshold, intra-prediction coding may be performed on the P frame as in the case of the I frame.

### 4) Criteria for Determining the I (Intra) Frame

Among the multiple frames, every k-th frame may be designated as an I frame. Alternatively, scores related to a correlation between frames may be set and a frame having a high score may be configured as an I frame.

### 5) Encoding/Decoding of I Frames

In encoding/decoding point cloud data having multiple frames, the geometry of the I frame may be encoded/decoded based on an octree or a predictive tree. Then, the attribute information about the I frame may be encoded/decoded based on the predictive/lifting transform scheme or the RAHT scheme based on the reconstructed geometry information.

### 6) Encoding/Decoding of P Frames

In encoding/decoding point cloud data having multiple frames, according to embodiments, the P frame may be encoded/decoded based on a reference frame.

In this case, the coding unit for inter-prediction of the P frame may be a frame, a tile, a slice, an LPU (also referred to as a first prediction unit), or a PU (also referred to as a second prediction unit).

Herein, roads and objects may be separated from point cloud data (or point cloud content) captured (or acquired) by LiDAR equipment, an LPU may be constructed from the points of the separated road, and a PU may be constructed from the points of the separated object(s). The point cloud data (or point cloud content) may be configured in frames, tiles or slices. In other words, point cloud content, frames, tiles, slices, etc. may be referred to as point cloud data. For example, roads and objects may be separated from slice-level point cloud data, an LPU may be constructed with the points of the road, and an LPU may be constructed with the points of the object.

Hereinafter, detailed descriptions are given of embodiments for separating roads and objects in frame-, tile-, or slice-level point cloud data.

### Removing Noise Based on Minimum Radius

In some embodiments, noise may be removed before separating roads and objects from point cloud data.

For example, for point cloud content captured by LiDAR equipment on a moving vehicle, a portion of the vehicle may be captured by the sensors depending on the installation location.

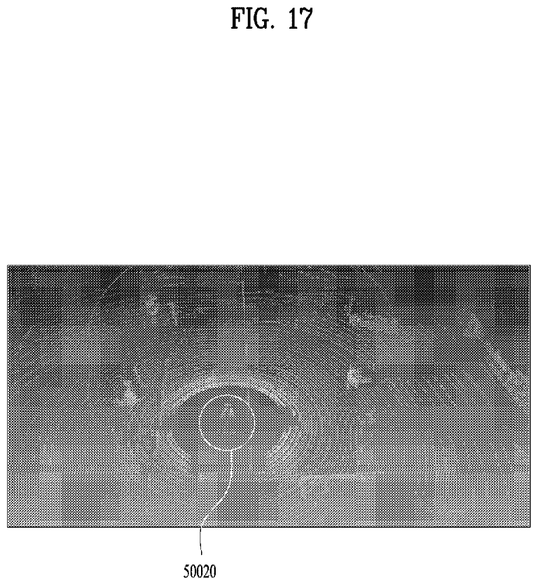

FIG. 17 is a diagram illustrating an example of point cloud data captured by LiDAR equipment according to embodiments.

As shown in FIG. 17, the center of the LiDAR equipment is captured as an origin (0,0,0), and there are points 50020 within a specific radius. The points may be an object, but may usually be a portion of a vehicle carrying the LiDAR equipment.

In one embodiment, the points 50020 within the specific radius may be considered as noise and removed.

In another embodiment, the points 50020 within a specific radius may be considered as a road, and the points 50020 may be separated as a road is separating the road and object. This is because, similar to is separating the road, motion may always appear constant across consecutive frames.

To identify the points 50020 that are within the specific radius, a minimum radius may be input and set or may be calculated and set. The points within the set radius may be considered as noise or as a road. For example, when considered as noise, the points are removed before separating the road and the object from the point cloud data.

According to embodiments, the method of separating the road and the object may be carried out based on an average radius for each laserID or an expected radius for each laserID. Here, the laserID is identification information for identifying each laser (or laser sensor), and may refer to a laser index.

Next, a detailed description is given of a method of separating a road and an object based on average radius.

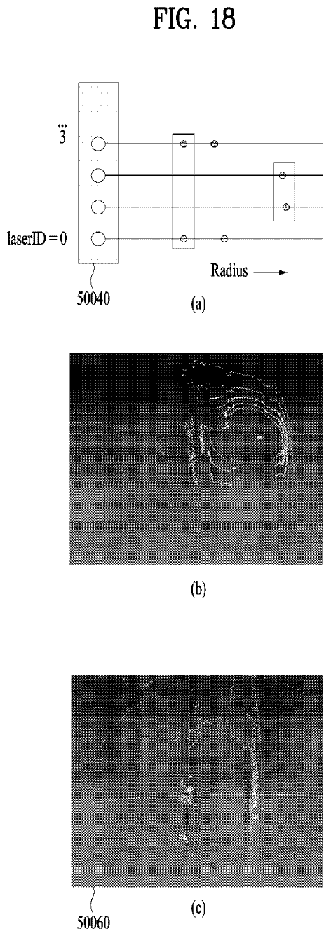

FIG. 18-(a) is a diagram illustrating example LiDAR equipment according to embodiments. FIGS. 18-(b) and 18-(c) are diagrams illustrating an example of point cloud data acquired using LiDAR equipment according to embodiments. In particular, FIG. 18-(b) is an enlarged view of a portion 50060 of FIG. 18-(c).

In one embodiment, in the LiDAR equipment of FIG. 18-(a), the laserID has a greater value at a higher position. In FIG. 18-(a), each laser sensor is shown to be arranged at no angle (i.e., parallel to the road) for ease of illustration. However, in practice, different laser sensors have different angles relative to the road. According to embodiments, the angle may be the angle at which each laser sensor faces downward.

In this case, for point cloud content captured by LiDAR equipment on a moving vehicle, as the laserID becomes larger (i.e., as the laser sensor goes upward), a road with a larger radius may be captured.

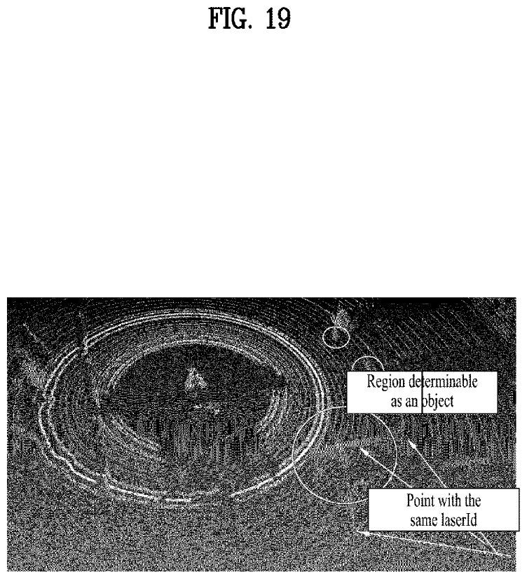

FIG. 19 is a diagram illustrating an example of separating objects from point cloud data according to embodiments.

Thus, roads and objects may be separated from point cloud data acquired by LiDAR equipment using the following method.

First, an average radius is calculated for each laserID. That is, for each laserID, the average of the radii within which the points are located is calculated. According to embodiments, in calculating the average radius, a threshold may be set, and point(s) outside of the threshold may not be included in the average radius. According to embodiments, threshold information (radius_threshold) may be input, and/or may be included in signaling information as inter-prediction-related optional information and transmitted to the receiving side. In the present disclosure, the inter-prediction-related option information may be referred to as motion option information or information related to separation of the road and the object.

In one embodiment, when the point(s) captured at the current laserID have a distance less than the average radius at the previous laserID (i.e., the expected distance), or when the radius at successive azimuths at the same laserID is outside a specific range (or the z value is outside a specific range), the points may be separated as an object as shown in FIG. 19. Conversely, when the point(s) captured at the current laserID have a distance greater than the average radius at the previous laserID (the expected distance), or when the radius at successive azimuths at the same laserID is within the specific range (or the z value is within the specific range), then the points are separated as a road.

Below is a detailed description of the method of separating a road and an object based on an expected radius (also referred to as a calculated radius). In other words, a method of separating a road and an object based on radius prediction from sensor position calculation is described.

As described above, for point cloud content captured by LiDAR equipment on a moving vehicle, as the laserID increases (i.e., the laser sensor position moves up, as shown in FIG. 18-(a)), a road with a larger radius may be captured by the corresponding laser sensor. In the case where an object is in the middle, the radius may become smaller and the elevation may increase, as shown in FIGS. 18 and 19.

Therefore, roads and objects may be separated from the point cloud data acquired by the LiDAR equipment by the following method

The radius (i.e., expected radius) r for each laserID may be calculated as shown in Equation 5.

Expected radius for each LaserID=tan(Angular theta degree value)*(Angular z+base_height) [Equation 5].

In Equation 5, base_height is the base height. In some embodiments, the relative distance of the center location of the LiDAR equipment from the road may be input as base_height, or the relative distance value may be calculated based on the first laserID and used as base_height. For F example, the relative distance (base_height) may be calculated by applying (radius*tan(θ)−z)+α.

The Angular theta degree (θ) denotes the angle of a sensor in the LiDAR equipment, and the Angular z (z) denotes the height of a sensor in the LiDAR equipment. For example, Angular theta degree[i] denotes an angle of the i-th laser sensor in the LiDAR equipment, and Angular z[i] denotes a height from the center of sensors in the LiDAR equipment to the i-th laser sensor.

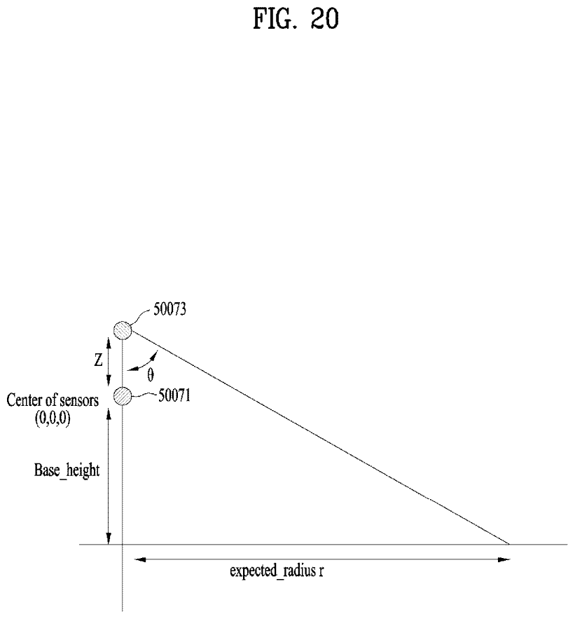

FIG. 20 is a diagram illustrating an example of predicting (or expecting) a radius by a specific laser sensor according to embodiments. In FIG. 20, 50071 represents the center of the sensors, and 50073 represents the i-th laser sensor. 0 is an angular theta degree representing an angle of the sensor in the LiDAR equipment, and z is an angular z representing a height of the sensor in the LiDAR equipment.

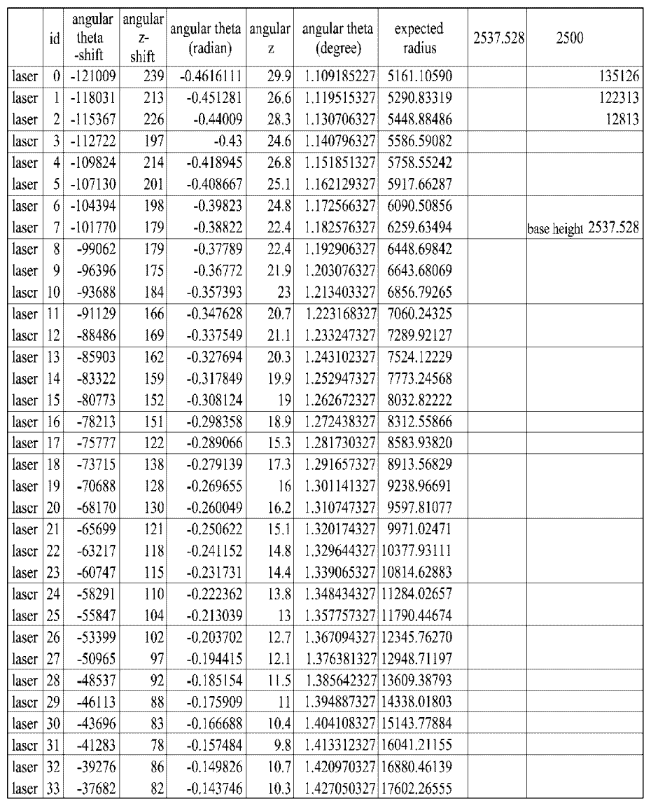

FIG. 21 is a table illustrating an example of calculating an expected radius according to embodiments.

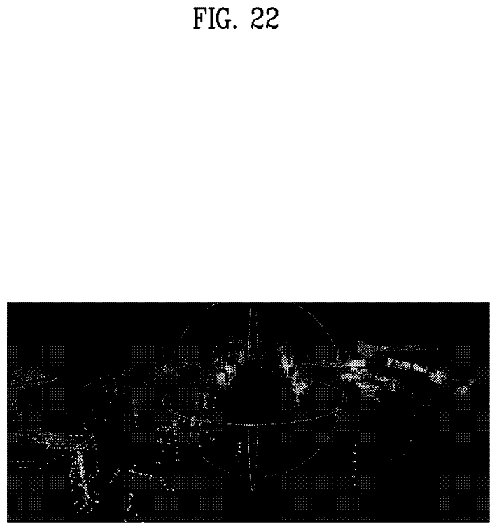

According to embodiments, when a distance based on the current laserID is less than the expected radius (i.e., calculated radius) (expected distance) at the previous laserID, or the radius at consecutive azimuths at the same laserID is outside a specific range (or the z value is outside a specific range), the points may be separated as an object as shown in FIG. 19. Conversely, when the distance based on the current laserID is greater than the expected radius (i.e., calculated radius) at the previous laserID, or the radius at consecutive azimuths at the same laserID is within a specific range (or the z value is within a specific range), the points are separated as a road, as shown in FIG. 22.

FIG. 22 is a diagram illustrating an example of separating a road from point cloud data composed of the road and objects, leaving only objects, according to embodiments.

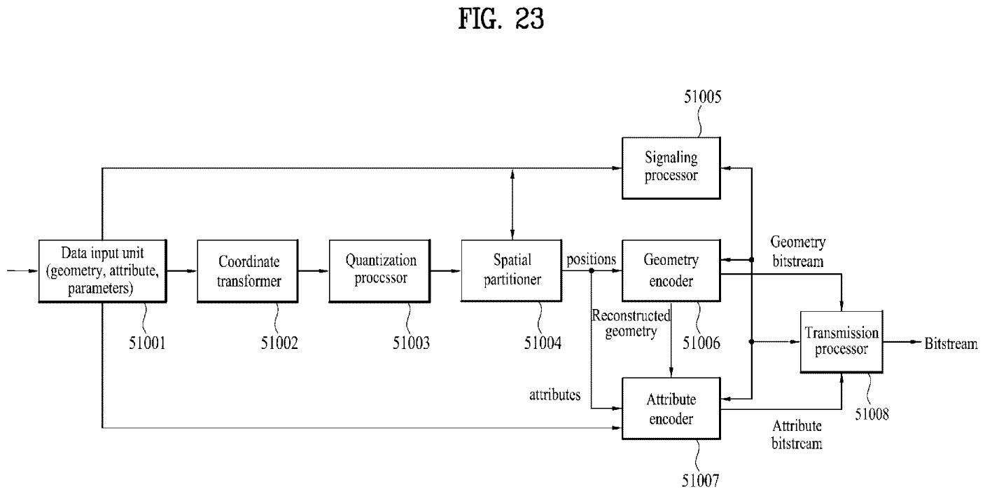

FIG. 23 is a diagram illustrating another example of a point cloud transmission device according to embodiments.

The point cloud transmission device according to the embodiments may include a data input unit 51001, a coordinate transformation unit 51002, a quantization processor 51003, a spatial partitioner 51004, a signaling processor 51005, a geometry encoder 51006, an attribute encoder 51007, and a transmission processor 51008. According to embodiments, the coordinate transformation unit 51002, the quantization processor 51003, the spatial partitioner 51004, the geometry encoder 51006, and the attribute encoder 51007 may be referred to as point cloud video encoders.

The point cloud data transmission device of FIG. 23 may correspond to the transmission device 10000 of FIG. 1, the point cloud video encoder 10002 of FIG. 1, the transmitter 10003 of FIG. 1, the acquisition 20000/encoding 20001/transmission 20002 of FIG. 2, the point cloud video encoder of FIG. 4, the transmission device of FIG. 12, the device of FIG. 14, and the like. Each component in FIG. 23 and the corresponding figures may correspond to software, hardware, a processor connected to a memory, and/or a combination thereof.

The data input unit 51001 may perform some or all of the operations of the point cloud video acquisition unit 10001 of FIG. 1, or may perform some or all of the operations of the data input unit 12000 of FIG. 12. The coordinate transformation unit 51002 may perform some or all of the operations of the coordinate transformation unit 40000 of FIG. 4. Further, the quantization processor 51003 may perform some or all of the operations of the quantization unit 40001 of FIG. 4, or may perform some or all of the operations of the quantization processor 12001 of FIG. 12. That is, the data input unit 51001 may receive data to encode the point cloud data. The data may include geometry data (which may be referred to as geometry, geometry information, etc.), attribute data (which may be referred to as an attribute, attribute information, etc.), and parameter information indicating coding-related settings.

The coordinate transformation unit 51002 may support coordinate transformation of the point cloud data, such as changing the xyz axes or transforming a Cartesian coordinate system (x, y, z) to a spherical coordinate system (r, φ, i).

The quantization processor 51003 may quantize the point cloud data. For example, it may adjust the compression rate of the point cloud data by multiplying the x, y, and z position values of the point cloud data by a scale according to a scale setting (scale-geometry quantization value). The scale may conform to a set value or may be included in the bitstream as parameter information and delivered to the receiving side.

The spatial partitioner 51004 may spatially partition the point cloud data quantized and output by the quantization processor 51003 into one or more 3D blocks based on a bounding box and/or a sub-bounding box. For example, the spatial partitioner 51004 may partition the quantized point cloud data into tiles or slices for region-by-region access or parallel processing of content. In one embodiment, the signaling information for spatial partition is entropy-encoded by the signaling processor 51005 and then transmitted through the transmission processor 51008 in the form of a bitstream.

In one embodiment, the point cloud content may be one person such as an actor, multiple people, one object, or multiple objects. In a larger range, it may be a map for autonomous driving or a map for indoor navigation of a robot. In this case, the point cloud content may be a vast amount of locally connected data. In this case, the point cloud content cannot be encoded/decoded at once, and accordingly tile partitioning may be performed before the point cloud content is compressed. For example, room #101 in a building may be partitioned into one tile and room #102 in the building may be partitioned into another tile. In order to support fast encoding/decoding by applying parallelization to the partitioned tiles, the tiles may be partitioned (or split) into slices again. This operation may be referred to as slice partitioning (or splitting).

That is, a tile may represent a partial region (e.g., a rectangular cube) of a 3D space occupied by point cloud data according to embodiments. According to embodiments, a tile may include one or more slices. The tile according to the embodiments may be partitioned into one or more slices, and thus the point cloud video encoder may encode point cloud data in parallel.

A slice may represent a unit of data (or bitstream) that may be independently encoded by the point cloud video encoder according to the embodiments and/or a unit of data (or bitstream) that may be independently decoded by the point cloud video decoder. A slice may be a set of data in a 3D space occupied by point cloud data, or a set of some data among the point cloud data. A slice according to the embodiments may represent a region or set of points included in a tile according to embodiments. According to embodiments, a tile may be partitioned into one or more slices based on the number of points included in one tile. For example, one tile may be a set of points partitioned by the number of points. According to embodiments, a tile may be partitioned into one or more slices based on the number of points, and some data may be split or merged in the partitioning process. That is, a slice may be a unit that may be independently coded within a corresponding tile. In this way, a tile obtained by spatially partitioning may be partitioned into one or more slices for fast and efficient processing.

The point cloud video encoder according to embodiments may encode the point cloud data on a slice-by-slice basis, or on a tile-by-tile basis, or on a frame-by-frame basis, wherein a tile includes one or more slices, and a frame includes one or more tiles. Further, the point cloud video encoder according to the embodiments may perform different quantization and/or transformation on a per-tile or per-slice basis.

The positions of the one or more 3D blocks (e.g., slices) spatially partitioned by the spatial partitioner 51004 are output to the geometry encoder 51006, and the attribute information (or attributes) is output to the attribute encoder 51007. The positions may be position information of points contained in a segmented unit (box or block or tile or group of tiles or slice), referred to as geometry information.

The geometry encoder 51006 performs inter- or intra-prediction based encoding on the positions output from the spatial partitioner 51004 to output a geometry bitstream. In this regard, for inter-prediction-based encoding of a P frame, the geometry encoder 51006 separates a road and objects from frame-level, tile-level or slice-level point cloud data by applying the road and object separation method described above to the frame-level, tile-level or slice-level point cloud data, and constructs LPUs from the points of the separated road and object(s). In some embodiments, no predicted motion may be applied to the LPU including the points classified as the road, and a predicted motion (e.g., global motion) may be applied to the LPU including the points classified as the object(s). In other embodiments, whether to apply the predicted motion to the LPU including the points of the road and/or the LPU including the points of the object(s) may be determined through rate distortion optimization (RDO), and the motion may be applied to the reference frame based on the determination. In other words, it may be predicted through RDO whether it is beneficial to apply a motion vector within the LPU including the points of the road and/or the LPU including the points of the object(s), and the result of the prediction may be signaled. In one embodiment, the motion vector may be a global motion vector. The motion vector may be a local motion vector. Further, the motion vector may be both a global motion vector and a local motion vector. Also, whether it is beneficial to apply the motion vector may be determined by comparing a bitstream size or the like given when the motion vector is applied. Furthermore, the global motion vector may be obtained by estimating the overall motion across frames. According to embodiments, based on the LPU including the points of the objects. PUs may be configured for the respective objects. The local motion vector may then be applied to the PUs. The geometry encoder 51006 may reconstruct the encoded geometry information and output the reconstructed information to the attribute encoder 51007.

The attribute encoder 51007 encodes (i.e., compresses) the attributes output from the spatial partitioner 51004 (e.g., split attribute sourced data) based on the reconstructed geometry output from the geometry encoder 51006 and outputs an attribute bitstream.

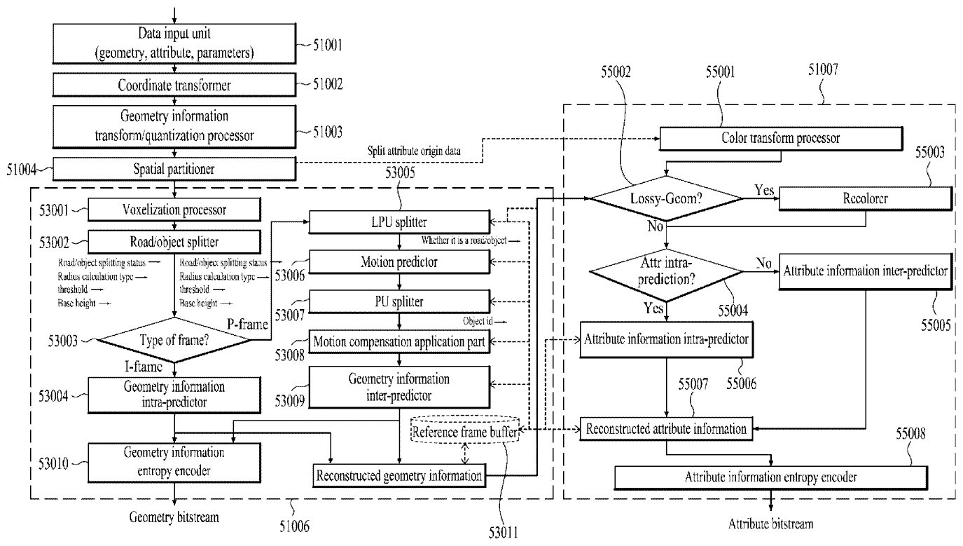

FIG. 24 is a diagram illustrating an example of operations of the geometry encoder 51006 and the attribute encoder 51007 according to embodiments.

In an embodiment, a quantization processor may be further provided between the spatial partitioner 51004 and the voxelization processor 53001. The quantization processor quantizes positions of one or more 3D blocks (e.g., slices) spatially partitioned by the spatial partitioner 51004. In this case, the quantization processor may perform some or all of the operations of the quantization unit 40001 of FIG. 4, or perform some or all of the operations of the quantization processor 12001 of FIG. 12. When the quantization processor is further provided between the spatial partitioner 51004 and the voxelization processor 53001, the quantization processor 51003 of FIG. 23 may or may not be omitted.

The voxelization processor 53001 according to the embodiments performs voxelization based on the positions of the one or more spatially partitioned 3D blocks (e.g., slices) or the quantized positions thereof. Voxelization refers to the minimum unit expressing position information in a 3D space. That is, the voxelization processor 53001 may support the process of rounding the geometry position values of the scaled points to integers. Points of point cloud content (or 3D point cloud video) according to embodiments may be included in one or more voxels. According to embodiments, one voxel may include one or more points. In an embodiment, in the case where quantization is performed before voxelization is performed, a plurality of points may belong to one voxel.

In the present disclosure, when two or more points are included in one voxel, the two or more points are referred to as duplicated points. That is, in the geometry encoding process, duplicated points may be generated through geometry quantization and voxelization.

The voxelization processor 53001 may output duplicated points belonging to one voxel without merging the points, or may merge the duplicated points into one point to be output.

According to embodiments, the points partitioned into tiles, slices or frames by the spatial partitioner 51004 are voxelized by the voxelization processor 53001, and the voxelized points are separated into a road or an object by a road/object splitter 53002.

According to embodiments, the road and object separation may be carried out based on an average radius for each laserID or an expected radius for each laserID, as described above.

According to embodiments, if the distance is less than an average radius at the previous laserID (i.e., an expected distance), or if the radius at successive azimuths at the same laserID is outside a specific range (or the z value is outside a specific range), the road/object splitter 53002 classifies the point(s) captured at the current laserID as an object. Otherwise, the splitter classifies the point(s) as a road. Here, the object may be one or more objects, which may be referred to as an object group. The z value denotes the height from the center of the sensors in the LiDAR equipment to the corresponding laser sensor.

According to embodiments, if the distance is less than an expected radius at the previous laserID (i.e., an expected distance), or if the radius at successive azimuths at the same laserID is outside a specific range (or the z value is outside a specific range), the road/object splitter 53002 classifies the point(s) captured at the current laserID as an object. Otherwise, the splitter classifies the point(s) as a road. Here, the object may be one or more objects, which may be referred to as an object group. The z value denotes the height from the center of the sensors in the LiDAR equipment to the corresponding laser sensor.

According to embodiments, in order to separate the road and objects described above, the road/object splitter 53002 may be provided with inter-prediction-related option information as input. According to embodiments, the inter-prediction-related option information may include information (road_object_split_flag) indicating whether to split the road/object, information (radius_type) indicating the type of split change (or radius calculation type), information (radius_threshold) indicating a threshold, and base height information (base_height). According to embodiments, the inter-prediction-related option information may further include identification information (lpu_id) for identifying an LPU, information (glh_is_road_flag) for identifying whether the LPU is an LPU composed of points of a road or points of an object (or objects), information (lpu_enable_global_motion) indicating whether global motion is applied to the LPU, information (pu_id) for identifying the PU, and information (object_id) for identifying each object. The inter-prediction-related option information may be included in at least one of a geometry parameter set, a tile parameter set (also referred to as a tile inventory), or a geometry slice header and transmitted to the receiving side. Further, the inter-prediction-related option information may be included in at least one of a geometry LPU header or a geometry PU header and transmitted to the receiving side.

For example, when the value of the information indicating whether to segment the road/object is true, the road/object splitter 53002 may split points in the frame-level or tile-level or slice-level point cloud data into a road and objects.

Then, the road/object splitter 53002 obtains an average (i.e., average radius) of the radii within which the points are located for each laserID when the value of the information (radius_type) indicating the type of split change indicates an average radius basis. In this operation, when calculating the average radius based on the value of the information (i.e., radius_threshold) indicating the threshold, the road/object splitter 53002 may not include the point(s) outside the threshold range in the average radius. In other words, the average radius may be obtained with the point(s) outside the threshold range excluded. Then, if the distance based on the current laserID is smaller than the average radius at the previous laserID (the expected distance), or if the radius at successive azimuths at the same laserID is outside a specific range (or the z value is outside a specific range), the points are classified as an object. Otherwise, the points are classified as a road.

When the value of the information (radius_type) indicating the split change type indicates the calculated radius basis, the road/object splitter 53002 receives a value of base_height or calculates a base height based on the average value of the first laserID, and obtains the radius (i.e., the expected radius) for each laserID according to Equation 5. Then, if the distance based on the current laserID is less than the expected radius (i.e., the expected distance) at the previous laserID or if the radius at successive azimuths at the same laserID is outside a specific range (or the z value is outside a specific range), the points are classified as an object. Otherwise, the points are classified as a road.

When the frame of the input point cloud data (i.e., the frame to which the input points belong) is an I frame, a geometry information intra-predictor 53004 according to embodiments may apply geometry intra-prediction coding to the geometry information about the I frame. Intra-prediction coding methods may include octree coding, predictive tree coding, and trisoup coding.

To this end, the element indicated by 53003 (also referred to as a determination part) checks whether the points output from the voxelization processor 53001 or the points separated into a road and an object by the road/object splitter 53002 belong to an I frame or a P frame.

When the frame identified by the determination part 53003 is a P frame, and the points in the frame-level, tile-level or slice-level point cloud data have been separated into a road and objects by the road/object splitter 53002, the LPU segmentation part 53005 constructs an LPU with points belonging to the road and an LPU with points belonging to the object(s) to support inter-prediction. Then, for each LPU, information (glh_is_road_flag) indicating whether the LPU is a road or an object (or an object group) may be signaled in inter-prediction related option information to be transmitted to the decoder on the receiving side. In other words, when the receiving side can identify whether the LPU transmitted from the transmitting side is composed of the points of the road or the points of the object(s), the road/object splitting operation may not be performed on the receiving side. Also, since the points in the point cloud data are split into LPUs based on whether they are the road or the object(s), the transmitted bitstream may be split into the road and the objects.

That is, once the points of the point cloud data are separated into a road and objects by the road/object splitter 53002, the LPU splitter 53005 constructs an LPU with the points separated into the road and another LPU with the points separated into the objects (or object group). Inter-prediction may then be performed by applying a global motion vector for each LPU or by using the previous frame. Here, using the previous frame means that no motion vector is used.

According to embodiments, a motion predictor 53006 may predict global motion for each LPU, and regions (i.e., LPUs) that need to be split may be split into PUs by a PU splitter 53007 to predict local motion. This process may be performed until no further PU splitting is required or up to a specified level. The LPU/PU splitting status and the predicted motion for each LPU/PU may be included in inter-prediction-related option information and transmitted to the decoder on the receiving side.

Then, a motion compensation application part 53008 may determine through the RDO whether to apply the predicted motion to the generated LPUs/PUs, and may apply the motion to a reference frame according to the determination. For example, when it determines through RDO that the gain of inter-prediction is large, it may perform motion compensation by applying the global motion vector and/or local motion vector obtained through motion prediction to the previous frame (i.e., the reference frame). In this regard, whether motion is applied for each LPU/PU may be included in the inter-prediction-related option information and transmitted to the decoder on the receiving side. Once motion compensation is performed, the geometry information may be compressed and signaled by a geometry information inter-predictor 53009 with the motion compensated points. That is, the geometry information inter-predictor 53009 performs inter-prediction based on the current LPU/PU and the previous frame that is motion compensated or the previous frame that is not motion compensated.

In other embodiments, the motion predictor 53006 may use global motion estimation to obtain a global motion vector for the LPU composed of the points of the object(s), and omit global motion estimation for the LPU composed of the points of the road. Further, the PU splitter 53007 may split the LPU composed of the points of the objects into as many PUs as the objects, and may not split the LPU composed of the points of the road into PUs. For example, when the objects included in the LPU composed of the points of the objects (or object) have different characteristics from each other, the LPU may be split into as many PUs as the objects, and each PU may be assigned an object ID (e.g., object_id). Furthermore, for each PU, a local motion vector may be obtained by motion prediction. Then, the object ID information assigned to each PU may be included in the inter-prediction-related option information along with the PU information and transmitted to the decoder on the receiving side. In this case, the motion compensation application part 53008 applies motion compensation to the LPU and/or PUs composed of the points of the object(s) and does not apply motion compensation to the LPU composed of the points of the road. The geometry information inter-predictor 53009 performs inter-predictions based on the current LPU/PU and a previous frame that is motion compensated or a previous frame that is not motion compensated.

In other embodiments, when the frame identified by the determination part 53003 is a P frame and the road/object splitter 53002 has not split roads and objects, the LPU splitter 53005 may split the points of the frame-level, tile-level or slice-level point cloud data voxelized by the voxelization processor 53001 into LPUs based on one or a combination of two or more of elevation, radius, and/or azimuth. Further, the LPUs may be further split into PUs based on one or a combination of two or more of elevation, radius, and/or azimuth. The motion compensation application part 53008 may then determine, through RDO, whether to apply the predicted motion to the split LPUs/PUs, and may apply the motion to the reference frame based on the determination. For example, when it determines through RDO that the gain of inter-prediction is large, it may perform motion compensation by applying the global motion vector and/or local motion vector obtained through motion prediction to the previous frame (i.e., the reference frame). In this regard, whether motion is applied for each LPU/PU may be included in the inter-prediction-related option information and transmitted to the decoder on the receiving side. Once motion compensation is performed, the geometry information may be compressed and signaled by a geometry information inter-predictor 53009 with the motion compensated points. That is, the geometry information inter-predictor 53009 performs inter-prediction based on the current LPU/PU and the previous frame that is motion compensated or the previous frame that is not motion compensated.

According to embodiments, to perform inter-prediction by the geometry information inter-predictor 53009, a reference frame is stored in a reference frame buffer 53011 and provided to the geometry information inter-predictor 53009 when needed.

As such, the LPU/PU splitter 53005 may construct (or generate) an LPU from the points of the object(s), another LPU from the points of the road, and the PU splitter 53007 may split the LPU composed of the points of the object(s) into PUs. Then, the motion predictor 53006 and the motion compensation application part 53008 apply predicted motion to the LPU and/or PUs composed of the points of the object(s) and do not apply motion to the LPU composed of the points of the road.

The geometry information inter-predictor 53009 according to embodiments, may perform octree-based inter-coding, predictive-tree-based inter-coding, or trisoup-based inter-coding based on a difference in geometry predicted value between the current frame and the reference frame that is motion compensated or a previous frame that is not motion compensated.

The geometry information intra-predictor 53004 may apply geometry intra-prediction coding to the geometry information about the I frame input through the determination part 53003. Method for intra-prediction coding may include octree coding, predictive tree coding, and trisoup coding.

A geometry information entropy encoder 53010 according to embodiments performs entropy encoding on the geometry information coded based on intra-prediction by the geometry information intra-predictor 53004 or based on inter-prediction by the geometry information inter-predictor 53009, and outputs a geometry bitstream (also referred to as a geometry information bitstream). In this case, if the points in the point cloud data have been separated into the road and the objects and processed, the geometry bitstream may be split into the road and the objects to be output.

A geometry reconstructor according to embodiments reconstructs (or restores) the geometry information based on the positions changed through intra-prediction-based coding or inter-prediction-based coding, and outputs the reconstructed geometry information (referred to as reconstructed geometry) to the attribute encoder 51007. This is because the reconstructed (or restored) geometry information is needed to compress the attribute information as the attribute information is dependent on the geometry information (positions). Further, the reconstructed geometry information is stored in the reference frame buffer 53011 so as to be provided as a reference frame for inter-prediction coding of the P frame. The reference frame buffer 53011 also stores the attribute information reconstructed by the attribute encoder 51007. That is, the reconstructed geometry information and reconstructed attribute information stored in the reference frame buffer 53011 may be used as a previous reference frame for geometry information inter-prediction coding and attribute information inter-prediction coding by the geometry information inter-predictor 53009 of the geometry encoder 51006 and the attribute information inter-predictor 55005 of the attribute encoder 51007.

The color transformation processor 55001 of the attribute encoder 51007 corresponds to the color transformation unit 40006 of FIG. 4 or the color transformation processor 12008 of FIG. 12. The color transformation processor 55001 according to the embodiments performs color transformation coding of transforming color values (or textures) included in the attributes provided from the data input unit 51001 and/or the spatial partitioner 51004. For example, the color transformation processor 55001 may transform the format of color information (e.g., from RGB to YCbCr). The operation of the color transformation processor 55001 according to the embodiments may be optionally applied according to color values included in the attributes. In another embodiment, the color transformation processor 55001 may perform color transformation coding based on the reconstructed geometry.

According to embodiments, the attribute encoder 51007 may perform recoloring according to whether lossy coding is applied to the geometry information. To this end, the element assigned reference numeral 55002 (or referred to as a determiner) checks whether the geometry encoder 51006 applies lossy coding to the geometry information.

For example, when it is determined by the determiner 55002 that lossy coding has been applied to the geometry information, the recolorer 55003 performs color re-adjustment (or recoloring) to reconfigure the attribute (color) due to the lost points. That is, the recolorer 55003 may find and reconfigure an attribute value appropriate for the position of the lost point in the source point cloud data. In other words, the recolorer 55003 may predict an attribute value suitable for the changed position when the position information value is changed because scale is applied to the geometry information.

According to embodiments, the operation of the recolorer 53003 may be optionally applied according to whether duplicated points are merged. According to an embodiment, merging of the duplicated points may be performed by the voxelization processor 53001 of the geometry encoder 51006.

In an embodiment of the present disclosure, when points belonging to a voxel are merged into one point by the voxelization processor 53001, the recolorer 55003 may perform color re-adjustment (i.e., recoloring).

The recolorer 55003 performs an operation and/or method that is the same as or similar to the operation and/or method of the attribute transformation unit 40007 of FIG. 4 or the attribute transformation processor 12009 of FIG. 12.

When it is determined by the determiner 55002 that lossy coding is not applied to the geometry information, it is checked by the element assigned reference numeral 55004 (or referred to as a determiner) whether inter-prediction-based encoding is applied to the geometry information.

When it is determined by the determiner 55004 that encoding based on inter prediction is not applied to the geometry information, the attribute information intra predictor 55006 performs intra-prediction coding on the input attribute information. According to embodiments, the intra-prediction coding method carried out by the attribute information intra predictor 55006 may include predicting transform coding, lift transform coding, and RAHT coding.

When it is determined by the determiner 55004 that inter-prediction-based encoding is applied to the geometry information, the attribute information inter-predictor 55005 performs inter-prediction coding on the input attribute information. According to embodiments, the attribute information inter-predictor 55005 may code a residual based on a difference in attribute prediction value between the current frame and a motion-compensated reference frame.

The attribute information entropy encoder 55008 according to the embodiments performs entropy encoding on the attribute information encoded by the attribute information intra-predictor 55006 based on intra prediction or the attribute information encoded by the attribute information inter-predictor 55005 based on inter prediction, and outputs an attribute bitstream (or referred to as an attribute information bitstream).

The attribute reconstructor according to the embodiments restores (or reconstructs) attribute information based on attributes changed through intra-predictive coding or inter-predictive coding, and stores the reconstructed attribute information (or referred to as the reconstructed attribute) in the frame buffer 53009. That is, the reconstructed geometry information and the reconstructed attribute information stored in the reference frame buffer 53009 are may be used as a previous reference frame for inter-predictive coding of geometry information and inter-predictive coding of the attribute information by the geometry information inter-predictor 53007 and the attribute information inter-predictor 55005 of the attribute encoder 51007.

The geometry bitstream compressed and output by the geometry encoder 51006 on an intra-prediction basis or an inter-prediction basis and the attribute bitstream compressed and output by the attribute encoder 51007 on an intra-prediction basis or an inter-prediction basis are output to a transmission processor 51008.

According to embodiments, the transmission processor 51008 may perform the same or similar operation and/or transmission method as the operation and/or transmission method of the transmission processor 12012 of FIG. 12, or may perform the same or similar operation and/or transmission method as the operations and/or transmission method of the transmitter 10003 of FIG. 1. For further details, refer to the description of FIG. 1 or 12, which will not be described below.

The transmission processor 51008 may transmit the geometry bitstream output from the geometry encoder 51006, the attribute bitstream output from the attribute encoder 51007, and the signaling bitstream output from the signaling processor 51005, respectively, or may multiplex the bitstreams into a single bitstream.

According to embodiments, the transmission processor 51008 may encapsulate the bitstreams into files or segments (e.g., streaming segments) and transmit the same over various networks, such as a broadcast network and/or a broadband network.

The signaling processor 51005 may generate and/or process signaling information and output the same to the transmission processor 51008 in the form of a bitstream. The signaling information generated and/or processed by the signaling processor 51005 may be provided to the geometry encoder 51006, the attribute encoder 51007, and/or the transmission processor 51008 for geometry encoding, attribute encoding, and transmission processing. Alternatively, the signaling processor 51005 may be provided with signaling information generated by the geometry encoder 51006, the attribute encoder 51007, and/or the transmission processor 51008.

As used herein, the signaling information may be signaled and transmitted on the basis of a parameter set, such as a sequence parameter set (SPS), geometry parameter set (GPS), attribute parameter set (APS), or tile parameter set (TPS) (also referred to as tile inventory). It may be signaled and transmitted per coding unit of each video, such as slice or tile. According to the present disclosure, the signaling information may include metadata related to the point cloud data (e.g., set values, etc.) and may be provided to the geometry encoder 51006, the attribute encoder 51007, and/or the transmission processor 51008 for geometry encoding, attribute encoding, and transmission processing. Depending on the application, signaling information may also be defined at the system level, such as a file format, dynamic adaptive streaming over HTTP (DASH), and MPEG media transport (MMT), or at the wired interface level, such as High Definition Multimedia Interface (HDMI), Display Port, Video Electronics Standards Association (VESA), and CTA.

The method/device according to embodiments may signal relevant information to add/perform operations of the embodiments. The signaling information may be used by a transmission device and/or a reception device.

In one embodiment, inter-prediction-related option information to be used for inter-prediction of geometry information may be signaled in at least one of a geometry parameter set, a tile parameter set, or a geometry slice header. Alternatively, it may be signaled in a separate LPU header (referred to as geom_lpu_header) and/or a PU header (referred to as geom_pu_header).

According to embodiments, the road/object separation and the LPU/PU generation based thereon may be performed by either the geometry encoder on the transmitting side or the geometry decoder on the receiving side. For example, when the road/object separation and the LPU/PU generation based thereon are performed by the geometry encoder on the transmitting side, they may be omitted on the receiving side. Conversely, whey omitted on the transmitting side, the road/object separation and the LPU/PU generation based thereon may be performed by the geometry decoder on the receiving side. According to embodiments of the present disclosure, whether to split a road/object may be determined based on the value of information indicating whether to split the road/object. For example, when the value of the information indicating whether to split the road/object input to the geometry encoder on the transmitting side is TRUE, the geometry encoder on the transmitting side may perform the road/object separation and the LPU/PU generation (or splitting) based thereon. Conversely, when the value of the information indicating whether to split the road/object input to the geometry decoder on the receiving side is TRUE, the geometry decoder on the receiving side may perform the road/object separation and the LPU/PU generation based thereon. In the former case, the value of the information indicating whether to split the road/object may be signaled as FALSE in the inter-prediction related option information and transmitted to the geometry decoder on the receiving side. In this case, the geometry decoder on the receiving side does not perform the operation of the road/object separation and LPU/PU generation based thereon.

In other words, all signaling information may be transmitted to the decoder on the receiving side. In this case, the road/object separation may only performed by the geometry encoder on the transmitting side, and the geometry decoder may be allowed to reconstruct the configuration of the bitstream by transmitting whether to split the road/object and object ID information to the geometry decoder of the receiving side using an LPU/PU. Thus, when only the geometry encoder may separate the road/object, and the road/object is separated and transmitted through the configuration of the bitstream, the value of the information indicating whether to separate the road/object may be signaled as FALSE when transmitted to the geometry decoder.

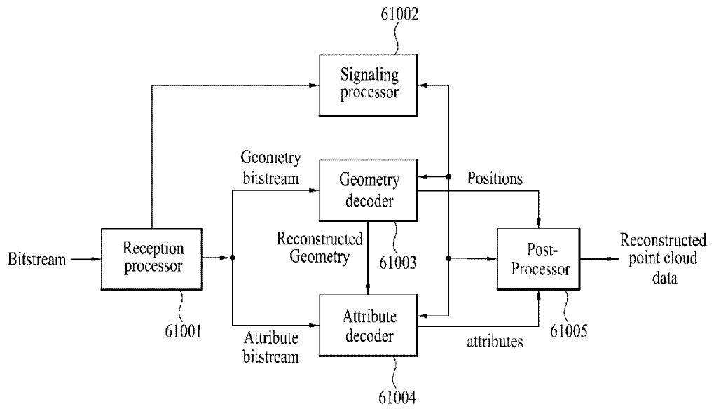

FIG. 25 is a diagram illustrating another example of a point cloud reception device according to embodiments.

A point cloud reception device according to embodiments may include a reception processor 61001, a signaling processor 61002, a geometry decoder 61003, an attribute decoder 61004, and a post-processor 61005. According to embodiments, the geometry decoder 61003 and the attribute decoder 61004 may be referred to as a point cloud video decoder. According to embodiments, the point cloud video decoder may be referred to as a PCC decoder, a PCC decoding unit, a point cloud decoder, a point cloud decoding unit, or the like.

The point cloud reception device of FIG. 25 may correspond to the reception device 10004, the receiver 10005, the point cloud video decoder 10006 of FIG. 1, the transmission 20002-decoding 20003-rendering 20004 of FIG. 2, the point cloud video decoder of FIG. 11, the reception device of FIG. 13, the device of FIG. 14, and the like. Each component in FIG. 25 and the corresponding figures may correspond to software, hardware, a processor connected to a memory, and/or a combination thereof.

The reception processor 61001 according to the embodiments may receive a single bitstream, or may receive a geometry bitstream (also called geometry information bitstream), an attribute bitstream (also called attribute information bitstream), and a signaling bitstream, respectively. In this case, the bitstreams (or geometry bitstream) may be received split into a road and objects. When a file and/or segment is received, the reception processor 61001 may decapsulate the received file and/or segment and output a bitstream.

When a single bitstream is received (or decapsulated), the reception processor 61001 may demultiplex the geometry bitstream, the attribute bitstream, and/or the signaling bitstream from the single bitstream. The reception processor 61001 may output the demultiplexed signaling bitstream to the signaling processor 61002, the geometry bitstream to the geometry decoder 61003, and the attribute bitstream to the attribute decoder 61004.

When the geometry bitstream, the attribute bitstream, and/or the signaling bitstream are received (or decapsulated), respectively, the reception processor 61001 may deliver the signaling bitstream to the signaling processor 61002, the geometry bitstream to the geometry decoder 61003, and the attribute bitstream to the attribute decoder 61004.

The signaling processor 61002 may parse signaling information, for example, information contained in the SPS, GPS, APS, TPS, metadata, or the like from the input signaling bitstream, process the parsed information, and provide the processed information to the geometry decoder 61003, the attribute decoder 61004, and the post-processor 61005. In another embodiment, signaling information contained in the geometry slice header and/or the attribute slice header may also be parsed by the signaling processor 61002 before the corresponding slice data is decoded. That is, when the point cloud data is partitioned into tiles and/or slices on the transmitting side, the TPS includes the number of slices included in each tile, and accordingly the point cloud video decoder according to the embodiments may check the number of slices and quickly parse the information for parallel decoding.

Accordingly, the point cloud video decoder according to the present disclosure may quickly parse a bitstream containing point cloud data as it receives an SPS having a reduced amount of data. The reception device may decode tiles upon receiving the tiles, and may decode each slice based on the GPS and APS included in each tile. Thereby, decoding efficiency may be maximized. Alternatively, the reception device may maximize the decoding efficiency by performing inter-prediction decoding on the point cloud data for each PU based on inter-prediction-related option information signaled in the GPS, TPS, geometry slice header, LPU header, and/or PU header.

That is, the geometry decoder 61003 may reconstruct the geometry by performing the reverse process to the operation of the geometry encoder 51006 of FIG. 23 on the compressed geometry bitstream based on the signaling information (e.g., geometry related parameters). The geometry restored (or reconstructed) by the geometry decoder 61003 is provided to the attribute decoder 61004. Here, the geometry-related parameters may include inter-prediction-related option information to be used for inter-prediction reconstruction of the geometry information.

Further, the geometry decoder 61003 may perform the road/object splitting and LPU/PU splitting (or generation) described above based on the inter-prediction-related optional information. For example, when the value of the information indicating whether to split the road/object (e.g., road_object_split_flag) included in the inter-prediction-related option information is FALSE, the road/object splitting and LPU/PU splitting (or generation) process may be performed based on the inter-prediction-related option information. When the road/object splitting and LPU/PU splitting are performed, motion compensation may be applied on the transmitting side for geometry information inter-prediction reconstruction, as described. Conversely, when the value of the information indicating whether to split the road/object included in the inter-prediction-related option information is TRUE, the road/object splitting and LPU/PU splitting (or generation) process may be omitted.

The attribute decoder 61004 may perform the reverse process to the operation of the attribute encoder 51007 of FIG. 23 on the compressed attribute bitstream based on the signaling information (e.g., attribute-related parameters) and the reconstructed geometry to reconstruct the attributes. According to embodiments, when the point cloud data has been split into tiles and/or slices on the transmitting side, the geometry decoder 61003 and attribute decoder 61004 may perform geometry decoding and attribute decoding on a per-tile and/or per-slice basis.

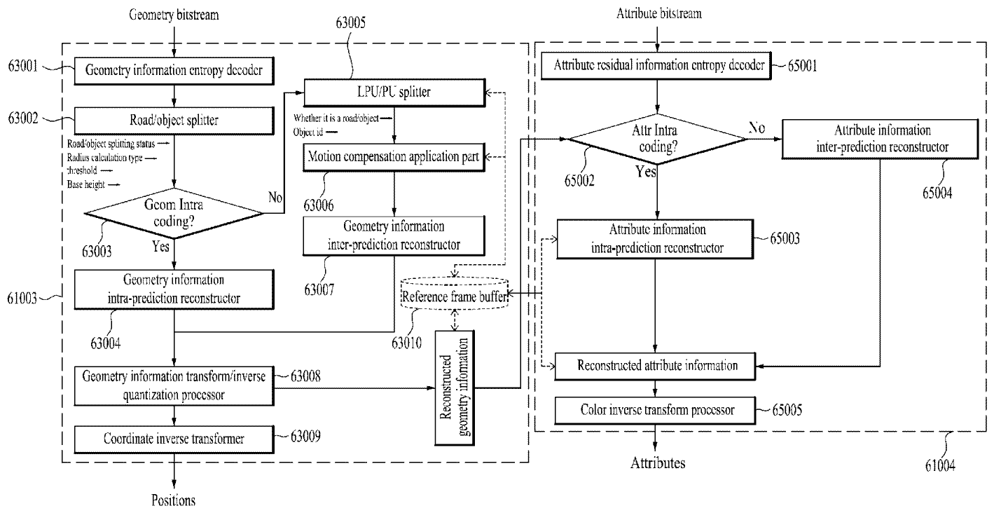

FIG. 26 is a diagram illustrating example operations of the geometry decoder 61003 and the attribute decoder 61004 according to embodiments.

The geometry information entropy encoder 63001, the inverse quantization processor 63008, and the coordinate inverse transformer 63009 included in the geometry decoder 61003 of FIG. 26 may perform some or all of the operations of the arithmetic decoder 11000 and the coordinate inverse transformer 11004 of FIG. 11, or perform some or all of the operations of the arithmetic decoder 13002 and the inverse quantization processor 13005 of FIG. 13. The positions reconstructed by the geometry decoder 61003 are output to the post-processor 61005.

According to embodiments, when the inter-prediction-related option information for inter-prediction reconstruction of geometry information is signaled through at least one of a geometry parameter set (GPS), a tile parameter set (TPS) (or referred to as a tile inventory), a geometry slice header, a geometry LPU header, or a geometry PU header, it may be obtained by the signaling processor 61002 and provided to the geometry decoder 61003, or may be obtained directly by the geometry decoder 61003.

According to embodiments, the inter-prediction-related option information may include information indicating whether to split the road/object (road_object_split_flag), information (radius_type) indicating the type of split change (or radius calculation type), information (radius_threshold) indicating a threshold, and base height information (base_height). According to embodiments, the inter-prediction-related option information may further include identification information (lpu_id) for identifying an LPU, information (glh_is_road_flag) for identifying whether the LPU is an LPU composed of points of a road or points of an object (or objects), information (lpu_enable global_motion) indicating whether global motion is applied to the LPU, information (pu_id) for identifying the PU, and information (object_id) for identifying each object. The inter-prediction-related option information may be included in at least one of a geometry parameter set, a tile parameter set (also referred to as a tile inventory), or a geometry slice header and received. Further, the inter-prediction-related option information may be included in at least one of a geometry LPU header or a geometry PU header and received. In the present disclosure, information to be included in the inter prediction-related option information may be added, deleted, or modified according to those skilled in the art, and thus the embodiments are not limited to the above-described example.

In other words, the geometry information entropy decoder 63001 entropy decodes the input geometry bitstream and outputs the decoded bitstream to the road/object splitter 63002.

When the value of the information indicating whether to split the road/object included in the inter-prediction-related option information is TRUE, the road/object splitter 63002 may split the road and objects from the entropy decoded geometry data based on the inter-prediction-related option information.

According to embodiments, the road and object separation may be performed based on an average radius for each laserID or an expected radius for each laserID, as described above.

According to embodiments, if the distance based on the current laserID is smaller than the average radius at the previous laserID (the expected distance), or if the radius at successive azimuths at the same laserID is outside a specific range (or the z value is outside a specific range), the road/object splitter 63002 classifies the points as an object. Otherwise, the splitter classifies the points as a road. Here, the object may be one or more objects, which may be referred to as an object group. The z value denotes the height from the center of the sensors in the LiDAR equipment to the corresponding laser sensor.

According to embodiments, if the distance based on the current laserID is less than an expected radius at the previous laserID (i.e., an expected distance), or if the radius at successive azimuths at the same laserID is outside a specific range (or the z value is outside a specific range), the road/object splitter 63002 classifies the points as an object. Otherwise, the splitter classifies the point(s) as a road. Here, the object may be one or more objects, which may be referred to as an object group. The z value denotes the height from the center of the sensors in the LiDAR equipment to the corresponding laser sensor.

According to embodiments, in order to separate the road and objects described above, the road/object splitter 63002 may be provided with inter-prediction-related option information. According to embodiments, the inter-prediction-related option information may include information indicating whether to split the road/object, information indicating the type of split change (or radius calculation type), information indicating a threshold, and base height information. According to embodiments, the inter-prediction-related information may further include object ID information assigned to each PU.

For example, the road/object splitter 63002 obtains an average (i.e., average radius) of the radii within which the points are located for each laserID when the value of the information (e.g., radius_type) indicating the type of split change indicates average radius-based. In this operation, when calculating the average radius based on the value of the information (i.e., threshold) indicating the threshold, the road/object splitter 63002 may not include the point(s) outside the threshold range in the average radius. In other words, the average radius may be obtained with the point(s) outside the threshold range excluded. Then, if the distance of the points captured at the current laserID is smaller than the average radius at the previous laserID (the expected distance), or if the radius at successive azimuths at the same laserID is outside a specific range (or the z value is outside a specific range), the points are classified as an object. Otherwise, the points are classified as a road.

When the value of the information (e.g., radius_type) indicating the split change type indicates the calculated radius basis, the road/object splitter 53002 receives a value of base_height or calculates a base height based on the average value of the first laserID, and obtains the radius (i.e., the expected radius) for each laserID according to Equation 5. Then, if the distance of the point(s) captured based on the current laserID is less than the expected radius (i.e., the expected distance) at the previous laserID or if the radius at successive azimuths at the same laserID is outside a specific range (or the z value is outside a specific range), the points are classified as an object. Otherwise, the points are classified as a road.

When the value of the information indicating whether to split the road/object included in the inter-prediction-related option information is FALSE, the road/object splitter 63002 does not perform the road/object splitting. Alternatively, if the bitstream is received split into the objects and road, and the inter-prediction-related information allows identifying whether the LPU is an LPU composed of points of the road or points of the objects, the road/object splitting may not be performed.

According to embodiments, when intra-prediction-based encoding is applied to the geometry information on the transmitting side, the geometry decoder 61003 performs intra-prediction-based reconstruction on the geometry information. On the other hand, when inter-prediction-based encoding is applied to the geometry information on the transmitting side, the geometry decoder 61003 performs inter-prediction-based reconstruction on the geometry information. If the bitstream is received split into a road and objects, the geometry information may be reconstructed by performing decoding on each of the road and objects.

To this end, the element assigned reference numeral 63002 (or referred to as a determination part) checks whether intra-prediction-based coding or inter-prediction-based coding is applied to the geometry information.

When it is determined by the determination part 63003 that intra-prediction-based coding is applied to the geometry information, the entropy-decoded geometry information is provided to a geometry information intra-prediction reconstructor 63004. On the other hand, when it is determined by the determination part 63003 that inter-prediction-based coding is applied to the geometry information, the entropy-decoded geometry information or the geometry information split into the road and objects by the road/object splitter 63002 is output to the LPU/PU splitter 63005.

The geometry information intra-prediction reconstructor 63004 decodes and reconstructs geometry information based on the intra-prediction method. That is, the geometry information intra-prediction reconstructor 63004 may reconstruct geometry information predicted by the geometry intra-prediction coding. The intra-prediction coding method may include octree-based coding, predictive-tree-based coding, and trisoup-based coding.

When the frame of geometry information to be decoded is a P frame, the LPU/PU splitter 63005 splits a reference frame into LPUs/PUs using inter-prediction-related option information signaled to support inter-prediction-based reconstruction and indicate LPU/PU split.

That is, the LPU/PU splitter 63005 generates LPUs using the points classified by the road/object splitter 63002. At this point, each LPU may be composed of a road and objects (or object group) based on inter-prediction-related option information. To this end, information for identifying whether each LPU is a road or an object (or an object group) (i.e., whether it is a road/object) may be included in the inter-prediction-related option information.

Further, an LPU split as an object group may be composed of multiple objects. Accordingly, the LPU/PU splitter 63005 may split the LPU composed of multiple objects into PUs when the objects have different characteristics, and utilize the inter-prediction related option information including object ID information assigned to each PU to reconstruct the inter-prediction related option information.

A motion compensation application part 63006 according to embodiments may apply motion vectors (e.g., a global motion vector and/or a local motion vector) to the LPUs/PUs split from a reference frame to generate predicted geometry information. Here, the motion vectors may be received through signaling information. In one embodiment, the motion compensation application part 63006 may determine whether to apply the motion vectors to the LPUs/PUs by referring to inter-prediction-related option information. In another embodiment, the motion compensation application part 63006 may perform motion compensation by applying a global motion vector to an LPU split as an object (or object group) and local motion vectors to PUs. Further, the motion compensation application part 63006 may omit the motion compensation for an LPU split as a road.

A geometry information inter-prediction reconstructor 63007 according to embodiments decodes and reconstructs geometry information based on the inter-prediction. That is, the geometry information coded by the geometry inter-prediction may be reconstructed based on the geometry information about a motion-compensated reference frame (or, a non-motion-compensated reference frame). Methods for Inter-prediction coding may include octree-based inter-coding, predictive-tree-based inter-coding, and trisoup-based inter-coding.

The geometry information reconstructed by the geometry information intra-prediction reconstructor 63004 or the geometry information reconstructed by the geometry information inter-prediction reconstructor 63007 is input to the geometry information inverse transform/inverse quantization processor 63008.

The geometry information inverse transform/inverse quantization processor 63008 performs the reverse process to the transformation performed by the geometry information transformation/quantization processor 51003 of the transmission device on the reconstructed geometry information, and the result may be multiplied by a scale (=geometry quantization value) to generate the reconstructed geometry information through inverse quantization. That is, the geometry information inverse transform/inverse quantization processor 63008 may inversely quantize the geometry information by applying the scale (scale-geometry quantization value) included in the signaling information to the x, y; and z values of the geometry position of the reconstructed point.

The coordinate inverse transformer 63009 may perform a reverse process to the coordinate transformation performed by the coordinate transformation unit 51002 of the transmission device on the inverse-quantized geometry information. For example, the coordinate inverse transformer 63009 may reconstruct the changed xyz axes on the transmitting side or inversely transform the transformed coordinates into xyz Cartesian coordinates.

According to embodiments, the geometry information inverse-quantized by the geometry information inverse transform/inverse quantization processor 63008 is stored in a reference frame buffer 63010 through a geometry reconstruction process, and is output to the attribute decoder 61004 for attribute decoding.

According to embodiments, an attribute residual information entropy decoder 65001 of the attribute decoder 61004 may entropy-decode an input attribute bitstream.

According to embodiments, when encoding based on intra-prediction is applied to the attribute information on the transmitting side, the attribute decoder 61004 performs intra-prediction-based reconstruction on the attribute information. On the other hand, when encoding based on inter-prediction is applied to the attribute information on the transmitting side, the attribute decoder 61004 performs inter-prediction-based reconstruction on the attribute information.

To this end, the element assigned reference numeral 65002 (or referred to as a determination part) checks whether intra-prediction-based coding or inter-prediction-based coding has been applied to the attribute information.

When the determination part 65002 determines that intra-prediction-based coding has been applied to the attribute information, the entropy-decoded attribute information is provided to the attribute information intra-prediction reconstructor 65003. On the other hand, when the determination part 65002 determines that inter-prediction-based coding is applied to the attribute information, the entropy-decoded attribute information is provided to the attribute information inter-prediction reconstructor 65004.

The attribute information inter-prediction reconstructor 65004 decodes and reconstructs the attribute information based on the inter-prediction method. That is, the attribute information predicted by inter-prediction coding is reconstructed.

The attribute information intra-prediction reconstructor 65003 decodes and reconstructs the attribute information based on the intra-prediction method. That is, the attribute information predicted by intra-prediction coding is reconstructed. The intra coding method may include predicting transform coding, lift transform coding, and RAHT coding.

According to embodiments, the reconstructed attribute information may be stored in the reference frame buffer 63010. The geometry information and attribute information stored in the reference frame buffer 63010 may be provided to the geometry information inter-prediction reconstructor 63007 and the attribute information inter-prediction reconstructor 65004 as a previous reference frame.

According to embodiments, the reconstructed attribute information may be provided to the color inverse transformation processor 65005 to reconstruct RGB colors. In other words, the color inverse transformation processor 65005 performs inverse transform coding for inverse transformation of the color values (or textures) included in the reconstructed attribute information, and then outputs the attributes to the post-processor 61005. The color inverse transformation processor 65005 performs an operation and/or inverse transform coding identical or similar to the operation and/or inverse transform coding of the color inverse transformer 11010 of FIG. 11 or the color inverse transformation processor 13010 of FIG. 13.

The post-processor 61005 may reconstruct point cloud data by matching the geometry information (i.e., positions) reconstructed and output by the geometry decoder 61003 with the attribute information reconstructed and output by the attribute decoder 61004. In addition, when the reconstructed point cloud data is in a tile and/or slice unit, the post-processor 61005 may perform a reverse process to the spatial partitioning on the transmitting side based on the signaling information.

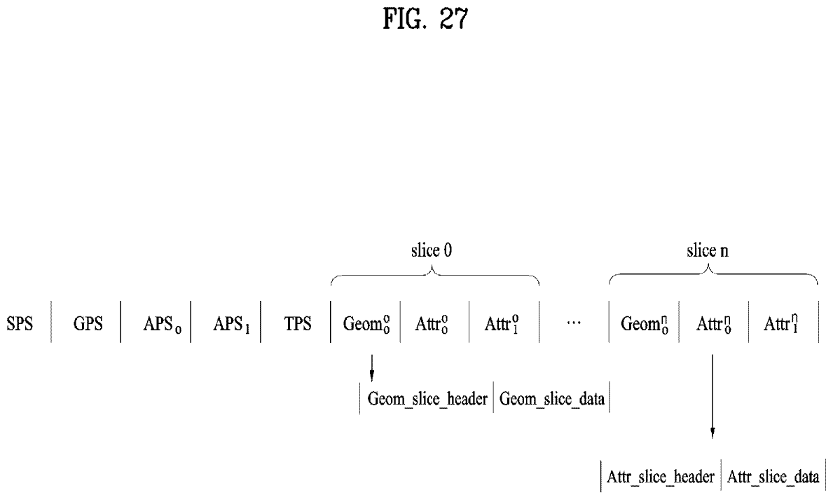

FIG. 27 illustrates an example bitstream structure of point cloud data for transmission/reception according to embodiments.

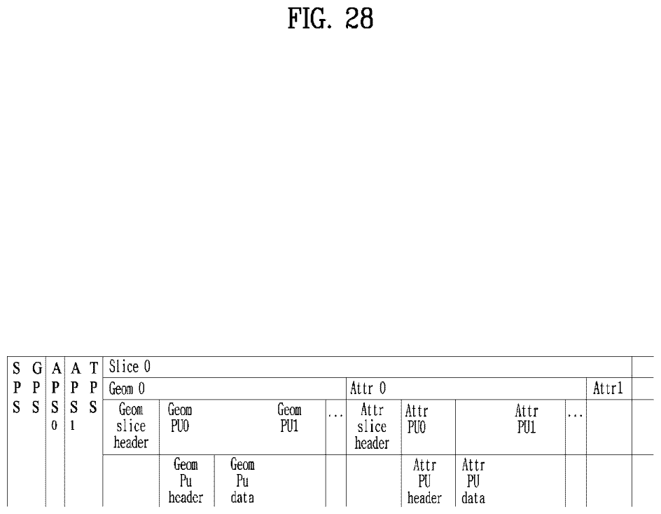

FIG. 28 illustrates another example bitstream structure of point cloud data for transmission/reception according to embodiments. That is, FIG. 28 is an example of applying LPUs/PUs to the bitstream structure of FIG. 27.

According to embodiments, the bitstream output from the point cloud video encoder of any one of FIGS. 1, 2, 4, 12, 23, and 24 may be in the form shown in FIG. 27 or 28.

According to embodiments, the term “slice” in FIG. 27 or FIG. 28 may be referred to as “data unit.”

In addition, in FIG. 27 or 28, each abbreviation has the following meaning. Each abbreviation may be referred to by another term within the scope of the equivalent meaning. SPS: Sequence Parameter Set: GPS: Geometry Parameter Set: APS: Attribute Parameter Set: TPS: Tile Parameter Set: Geom: Geometry bitstream=geometry slice header+[geometry PU header+Geometry PU data] | geometry slice data): Attr: Attribute bitstream=attribute data unit header+[attribute PU header+attribute PU data] | attribute data unit data: LPU: Large Prediction Unit: PU: Prediction Unit.

In the present disclosure, related information may be signaled in order to add/perform the embodiments described so far. Signaling information according to embodiments may be used by a point cloud video encoder on the transmitting side or a point cloud video decoder on the receiving side.

The point cloud video encoder according to the embodiments may generate a bitstream as shown in FIG. 27 or 28 by encoding geometry information and attribute information as described above. In addition, signaling information related to the point cloud data may be generated and processed by at least one of the geometry encoder, the attribute encoder, or the signaling processor of the point cloud video encoder, and may be included in the bitstream.

As an example, the point cloud video encoder configured to perform geometry encoding and/or attribute encoding may generate an encoded point cloud (or a bitstream including the point cloud) as shown in FIG. 27 or 28. In addition, signaling information related to the point cloud data may be generated and processed by the metadata processor of the point cloud data transmission device, and be included in the point cloud as shown in FIG. 27 or 28.

The signaling information may be received/acquired by at least one of the geometry decoder, the attribute decoder, or the signaling processor of the point cloud video decoder.

A bitstream according to embodiments may be divided into a geometry bitstream, an attribute bitstream, and a signaling bitstream and transmitted/received, or one combined bitstream may be transmitted/received.

When a geometry bitstream, an attribute bitstream, and a signaling bitstream according to embodiments are configured in one bitstream, the bitstream may include one or more sub-bitstreams. The bitstream according to the embodiments may include a sequence parameter set (SPS) for sequence level signaling, a geometry parameter set (GPS) for signaling of geometry information coding, one or more attribute parameter sets (APSs) (APS₀, APS₁) for signaling of attribute information coding, a tile parameter set (TPS) (also referred to as a tile inventory) for signaling at the tile level, and one or more slices (slice 0) to slice n). That is, a bitstream of point cloud data according to embodiments may include one or more tiles, and each of the tiles may be a slice group including one or more slices (slice 0 to slice n). The TPS according to the embodiments may contain information about each of the one or more tiles (e.g., coordinate value information and height/size information about the bounding box). Each slice may include one geometry bitstream (Geom0) and one or more attribute bitstreams (Attr0) and Attr1).

The geometry bitstream (or called geometry slice) in each slice may include a geometry slice header and one or more geometry PUs (Geom PU0, Geom PU1). Each geometry LPU may include a geom LPU header and geom LPU data. Each geometry PU may include a geom PU header and geom PU data.

Each attribute bitstream (or attribute slice) in each slice may include an attribute slice header and one or more attribute PUs (Attr PU0, Attr PU1). Each attribute LPU may include an Attr LPU header and Attr LPU data. Each attribute PU may include an attr PU header and attr PU data.

A portion of the inter-prediction-related option information according to the embodiments may be added to and signaled in the GPS and/or TPS (also referred to as tile inventory).

A portion of the inter-prediction-related option information may be added to and signaled in the geometry slice header for each slice.

A portion of the inter-prediction-related option information may be signaled in the geom LPU header.

A portion of the inter-prediction-related option information may be signaled in the geom PU header.

In the president disclosure, the inter-prediction-related option information for road/object splitting is used interchangeably with motion option information for road/object splitting.

According to embodiments, parameters required for encoding and/or decoding of point cloud data may be newly defined in parameter sets (e.g., SPS, GPS, APS, and TPS (or referred to as a tile inventory), etc.) of the point cloud data and/or the header of the corresponding slice. For example, they may be added to the GPS in encoding and/or decoding geometry information, and may be added to the tile (TPS) and/or slice header in performing tile-based encoding and/or decoding. They parameters may be added to the Geom LPU header and/or the Attr LPU header in performing LPU-based encoding and/or decoding. Also, when PU-based encoding and/or decoding is performed, the parameters may be added to the geometry PU header and/or attribute PU header.

As shown in FIG. 28, the bitstream of the point cloud data is divided into tiles, slices, LPUs, and/or PUs such that the point cloud data may be divided into regions to be processed. The regions of the bitstream may have different importance levels. Accordingly, when the point cloud data is divided into tiles, different filters (encoding methods) or different filter units may be applied to the tiles, respectively. When the point cloud data is divided into slices, different filters or different filter units may be applied to the respective slices, respectively. When the point cloud data is divided into LPUs, different filters or different filter units may be applied to the LPUs, respectively. Also, when the point cloud data is divided into PUs, different filters or different filter units may be applied to the PUS, respectively.

By transmitting the point cloud data according to the bitstream structure as shown in FIG. 27 or 28, the transmission device according to the embodiments may allow the encoding operation to be applied differently according to the importance level, and allow a good-quality encoding method to be used in an important region. In addition, it may support efficient encoding and transmission according to the characteristics of the point cloud data and provide attribute values according to user requirements.

As the reception device according to the embodiments receives the point cloud data according to the bitstream structure as shown in FIG. 27 or 28, it may apply different filtering (decoding methods) to the respective regions (regions divided into tiles or slices) according to the processing capacity of the reception device, rather than using a complex decoding (filtering) method to the entire point cloud data. Thereby, a better image quality may be provided for regions important to the user and appropriate latency may be ensured in the system.

As described above, tiles or slices are provided to process the point cloud data by dividing the point cloud data into regions. In dividing the point cloud data into regions, an option to generate a different set of neighbor points for each region may be set. Thereby, a selection method having low complexity and slightly lower reliability, or a selection method having high complexity and high reliability I may be provided.

According to embodiments, at least one of the GPS, TPS, geometry slice header, geometry LPU header, or geometry PU header may include inter-prediction-related option information.

According to embodiments, the inter-prediction-related option information may include information indicating whether to split the road/object (road_object_split_flag), information (radius_type) indicating the type of split change (or radius calculation type), information (radius_threshold) indicating a threshold, and base height information (base_height). According to embodiments, the inter-prediction-related option information may further include identification information (lpu_id) for identifying an LPU, information (glh_is_road_flag) for identifying whether the LPU is an LPU composed of points classified into a road or points classified into an object (or objects), information (lpu_enable_global_motion) indicating whether global motion is applied to the LPU, information (pu_id) for identifying the PU, and information (object_id) for identifying each object. A portion of the information contained in the inter-prediction-related option information may be signaled in the GPS, while other portions (or duplicate information) may be signaled in the TPS or geometry slice header. Additionally, a portion of the information contained in the optional inter-prediction-related information may be signaled in the geometry LPU header and other portions of the information (or duplicate information) may be signaled in the geometry PU header.

A field, which is a term used in syntaxes that will be described later in the present disclosure, may have the same meaning as a parameter or a syntax element.

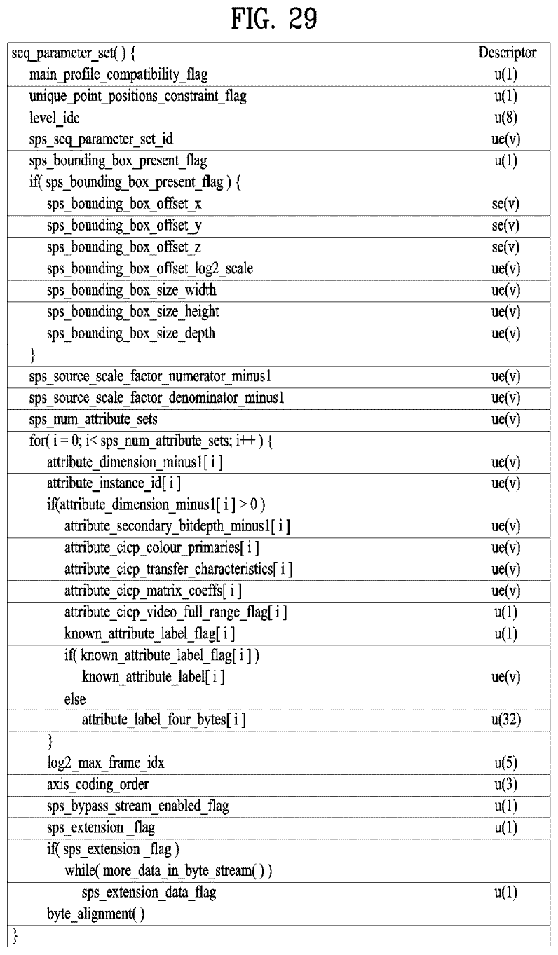

FIG. 29 is a diagram illustrating an embodiment of a syntax structure of a sequence parameter set (SPS) (seq_parameter_set_rbsp( )) according to the present disclosure. The SPS may include sequence information about a point cloud data bitstream.

The according to the SPS embodiments may include a main_profile_compatibility_flag field, a unique_point_positions_constraint_flag field, a level_idc field, an sps_seq_parameter_set_id field, an sps_bounding_box_present_flag field, an sps_source_scale_factor_numerator_minus1 field, an sps_source_scale_factor_denominator_minus1 field, an sps_num_attribute_sets field, log 2_max_frame_idx field, an axis_coding_order field, an sps_bypass_stream_enabled_flag field, and an sps_extension_flag field.

The main_profile_compatibility_flag field may indicate whether the bitstream conforms to the main profile. For example, main_profile_compatibility_flag equal to 1 may indicate that the bitstream conforms to the main profile. For example, main_profile_compatibility_flag equal to 0 may indicate that the bitstream conforms to a profile other than the main profile.

When unique_point_positions_constraint_flag is equal to 1, in each point cloud frame that is referenced by the current SPS, all output points may have unique positions. When unique_point_positions_constraint_flag is equal to 0, in any point cloud frame that is referenced by the current SPS, two or more output points may have the same position. For example, even when all points are unique in the respective slices, slices in a frame and other points may overlap. In this case, unique_point_positions_constraint_flag is set to 0.

level_idc indicates a level to which the bitstream conforms.

sps_seq_parameter_set_id provides an identifier for the SPS for reference by other syntax elements.

The sps_bounding_box_present_flag field indicates whether a bounding box is present in the SPS. For example, sps_bounding_box_present_flag equal to 1 indicates that the bounding box is present in the SPS, and sps_bounding_box_present_flag equal to 0 indicates that the size of the bounding box is undefined.

According to embodiments, when sps_bounding_box_present_flag is equal to 1, the SPS may further include an sps_bounding_box_offset_x field, an sps_bounding_box_offset_y field, an sps_bounding_box_offset_z field, an sps_bounding_box_offset_log 2_scale field, an sps_bounding_box_size_width field, an sps_bounding_box_size_height field, and an sps_bounding_box_size_depth field.

sps_bounding_box_offset_x indicates the x offset of the source bounding box in Cartesian coordinates. When the x offset of the source bounding box is not present, the value of sps_bounding_box_offset_x is 0.

sps_bounding_box_offset_y indicates the y offset of the source bounding box in Cartesian coordinates. When the y offset of the source bounding box is not present, the value of sps_bounding_box_offset y is 0.

sps_bounding_box_offset_z indicates the z offset of the source bounding box in Cartesian coordinates. When the z offset of the source bounding box is not present, the value of sps_bounding_box_offset_z is 0.

sps_bounding_box_offset_log 2_scale indicates a scale factor for scaling quantized x, y, and z source bounding box offsets.

sps_bounding_box_size_width indicates the width of the source bounding box in Cartesian coordinates. When the width of the source bounding box is not present, the value of sps_bounding_box_size_width may be 1.

sps_bounding_box_size_height indicates the height of the source bounding box in Cartesian coordinates. When the height of the source bounding box is not present, the value of sps_bounding_box_size_height may be 1.

sps_bounding_box_size_depth indicates the depth of the source bounding box in Cartesian coordinates. When the depth of the source bounding box is not present, the value of sps_bounding_box_size_depth may be 1.

sps_source_scale_factor_numerator_minus1 plus 1 indicates the scale factor numerator of the source point cloud.

sps_source_scale_factor_denominator_minus1 plus 1 indicates the scale factor denominator of the source point cloud.

sps_num_attribute_sets indicates the number of coded attributes in the bitstream.

The SPS according to the embodiments includes an iteration statement repeated as many times as the value of the sps_num_attribute_sets field. In an embodiment, i is initialized to 0, and is incremented by 1 each time the iteration statement is executed. The iteration statement is repeated until the value of i becomes equal to the value of the sps_num_attribute_sets field. The iteration statement may include an attribute_dimension_minus1[i] field and an attribute_instance_id[i] field. attribute_dimension_minus1[i] plus 1 indicates the number of components of the i-th attribute.

attribute_instance_id[i] specifies the instance ID of the i-th attribute.

According to embodiments, when the value of the attribute_dimension_minus1[i] field is greater than 1, the iteration statement may further include an attribute_secondary_bitdepth_minus1[i] field, an attribute_cicp_colour_primaries[i] field, an attribute_cicp_transfer_characteristics[i] field, an attribute_cicp_matrix_coeffs[i] field, and an attribute_cicp_video_full_range_flag[i] field.

attribute_secondary_bitdepth_minus1[i] plus 1 specifies the bitdepth for the secondary component of the i-th attribute signal(s).

attribute_cicp_colour_primaries[i] indicates the chromaticity coordinates of the color attribute source primaries of the i-th attribute.

attribute_cicp_transfer_characteristics[i] either indicates the reference opto-electronic transfer characteristic function of the color attribute as a function of a source input linear optical intensity with a nominal real-valued range of 0 to 1 or indicates the inverse of the reference electro-optical transfer characteristic function as a function of an output linear optical intensity

attribute_cicp_matrix_coeffs[i] describes the matrix coefficients used in deriving luma and chroma signals from the green, blue, and red, or Y, Z, and X primaries of the i-th attibute.

attribute_cicp_video_full_range_flag[i] specifies the black level and range of the luma and chroma signals as derived from E′Y, E′PB, and E′PR or E′R, E′G, and E′B real-valued component signals of the i-th attibute.

The known_attribute_label_flag[i] field indicates whether a known_attribute_label[i] field or an attribute_label_four_bytes[i] field is signaled for the i-th attribute. For example, when known_attribute_label_flag[i] equal to 0 indicates the known_attribute_label[i] field is signaled for the i-th attribute, known_attribute_label_flag[i] equal to 1 indicates that the attribute_label_four_bytes[i] field is signaled for the i-th attribute.

known_attribute_label[i] specifies the type of the i-th attribute. For example, known_attribute_label[i] equal to 0) may specify that the i-th attribute is color. known_attribute_label[i] equal to 1 may specify that the i-th attribute is reflectance. known_attribute_label[i] equal to 2 may specify that the i-th attribute is frame index. Also, known_attribute_label[i] equal to 4 specifies that the i-th attribute is transparency. known_attribute_label[i] equal to 5 specifies that the i-th attribute is normals.

attribute_label_four_bytes[i] indicates the known attribute type with a 4-byte code.

According to embodiments, attribute_label_four_bytes[i] equal to 0 may indicate that the i-th attribute is color. attribute_label_four_bytes[i] equal to 1 may indicate that the i-th attribute is reflectance. attribute_label_four_bytes[i] equal to 2 may indicate that the i-th attribute is a frame index. attribute_label_four_bytes[i] equal to 4 may indicate that the i-th attribute is transparency. attribute_label_four_bytes[i] equal to 5 may indicate that the i-th attribute is normals.

log 2_max_frame_idx indicates the number of bits used to signal a syntax variable frame_idx.

axis_coding_order specifies the correspondence between the X, Y, and Z output axis labels and the three position components in the reconstructed point cloud RecPic [pointidx][axis] with and axis=0 . . . 2.

sps_bypass_stream_enabled_flag equal to 1 specifies that the bypass coding mode may be used in reading the bitstream. As another example, sps_bypass_stream_enabled_flag equal to 0 specifies that the bypass coding mode is not used in reading the bitstream.

sps_extension_flag indicates whether the sps_extension_data syntax structure is present in the SPS syntax structure. For example, sps_extension_present_flag equal to 1 indicates that the sps_extension_data syntax structure is present in the SPS syntax structure. sps_extension_present_flag equal to 0 indicates that this syntax structure is not present.

When the value of the sps_extension_flag field is 1, the SPS according to the embodiments may further include an sps_extension_data_flag field.

sps_extension_data_flag may have any value.

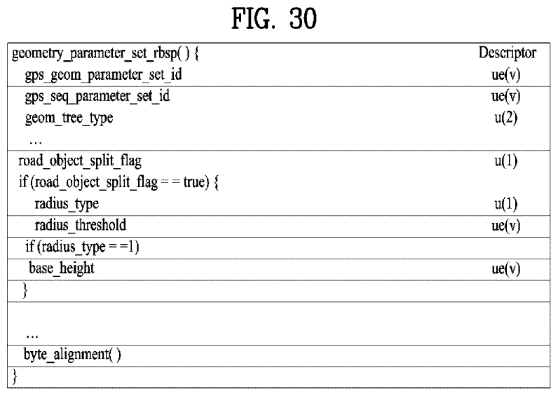

FIG. 30 is a diagram illustrating an embodiment of a syntax structure of a geometry parameter set (geometry_parameter_set( )) (GPS) including inter-prediction-related option information according to embodiments. The GPS may include information about a method of encoding geometry information related to the point cloud data contained in the one or more slices.

According to embodiments, inter-prediction-related option information (e.g., motion option information related to point road/object splitting) may be added to the geometry parameter set (GPS) and signaled for encoding/decoding of the geometry information on a frame-by-frame basis. In other words, by combining one or more pieces of inter-prediction-related option information included in the GPS, inter-prediction of the geometry may be efficiently supported. As used herein, the names of signaling information may be understood within the scope of the meaning and functionality of the signaling information.

The GPS according to embodiments may include at least a gps_geom_parameter_set_id field, a gps_seq_parameter_set_id field, a geom_tree_type field, and a road_object_split_flag field.

The gps_geom_parameter_set_id field provides an identifier for the GPS for reference by other syntax elements.

The gps_seq_parameter_set_id field specifies the value of sps_seq_parameter_set_id for the active SPS.

geom_tree_type indicates the coding type of geometry information. For example, geom_tree_type equal to 0 may indicate that geometry information (i.e., position information) is coded using an octree, and geom_tree_type equal to 1 may indicate that the information is coded using a predictive tree.

The road_object_split_flag field specifies whether road/object splitting has been applied to the frame. For example, when the value of road_object_split_flag is TRUE, it may indicate that road/object splitting has been applied to the frame.

When the value of road_object_split_flag is TRUE, the GPS according to the embodiments may further include a radius_type field and a radius_threshold field. When the value of the radius_type field is 1, the GPS may further include a base_height field.

The radius_type field specifies a radius calculation method for each laserID applied to the frame. For example, radius_type equal to 0 may indicate an average radius basis, while radius_type equal to 1 may indicate radius prediction (i.e., expected radius) based on sensor position calculation. The method of separating roads and objects based on the average radius or expected radius has been described in detail above and will not be described below:

When the road/object splitting method applied to the frame is based on the average radius, the radius_threshold field specifies a threshold of the point(s) to be excluded from the average radius calculation.

When the road/object splitting method applied to the frame is based on radius prediction through sensor position calculation, the base_height field specifies the base height to a sensor applied to the frame. In another embodiment, the base height may be acquired through calculation.

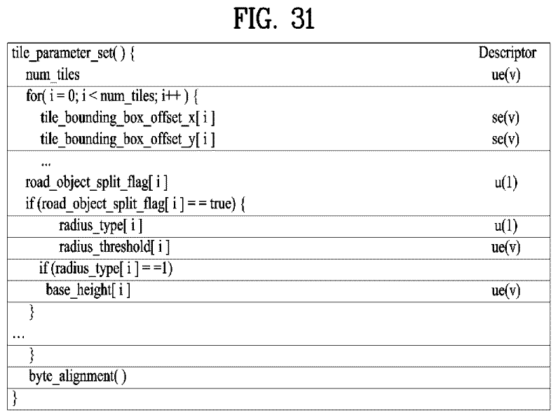

FIG. 31 is a diagram illustrating an embodiment of a syntax structure of a tile parameter set (tile_parameter_set( )) (TPS) that includes inter-prediction-related option information according to embodiments. In the embodiments, the TPS may also be referred to as a tile inventory. The TPS includes information related to each tile on a per-tile basis.

According to embodiments, inter-prediction-related option information (e.g., motion option information related to point road/object splitting) may be added to the tile parameter set (TPS) and signaled for encoding/decoding of the geometry information on a tile-by-tile basis. In other words, by combining one or more pieces of inter-prediction-related option information included in the TPS, inter-prediction of the geometry may be efficiently supported. As used herein, the names of signaling information may be understood within the scope of the meaning and functionality of the signaling information.

The TPS according to the embodiments includes a num_tiles field.

The num_tiles field indicates the number of tiles signaled for the bitstream. When not present, num_tiles is inferred to be 0.

The TPS according to the embodiments includes an iteration statement repeated as many times as the value of the num_tiles field. In an embodiment, i is initialized to 0, and is incremented by 1 each time the iteration statement is executed. The iteration statement is repeated until the value of i becomes equal to the value of num_tiles. The iteration statement may include a tile_bounding_box_offset_x[i] field, a tile_bounding_box_offset_y[i] field, a tile_bounding_box_offset_z[i] field, a tile_bounding_box_size_width[i] field, a tile_bounding_box_size_height[i] field, a tile_bounding_box_size_depth[i] field, and a road_object_split_flag[i] field. When the value of road_object_split_flag[i] is TRUE, the iteration statement may further include a radius_type[i] field and a radius_threshold[i]. When the value of radius_type[i] is 1, the iteration statement may further include a base_height[i] field.

The tile_bounding_box_offset_x[i] field indicates the x offset of the i-th tile in the Cartesian coordinates.

The tile_bounding_box_offset_y[i] field indicates the y offset of the i-th tile in the Cartesian coordinates.

The tile_bounding_box_offset_z[i] field indicates the z offset of the i-th tile in the Cartesian coordinates.

The tile_bounding_box_size_width[i] field indicates the width of the i-th tile in the Cartesian coordinates.

The tile_bounding_box_size_height[i] field indicates the height of the i-th tile in the Cartesian coordinates.

The tile_bounding_box_size_depth[i] field indicates the depth of the i-th tile in the Cartesian coordinates.

The road_object_split_flag[i] field specifies whether road/object splitting has been applied to the frame. For example, when the value of road_object_split_flag[i] is TRUE, it may indicate that road/object splitting has been applied to the i-th tile.

The radius_type[i] field specifies a radius calculation method for each laserID applied to the frame. For example, radius_type[i] equal to 0 may indicate an average radius basis, while radius_type equal to 1 may indicate radius prediction (i.e., expected radius) based on sensor position calculation. The method of separating roads and objects based on the average radius or expected radius has been described in detail above and will not be described below:

When the road/object splitting method applied to the i-th tile is based on the average radius, the radius_threshold[i] field specifies a threshold of the point(s) to be excluded from the average radius calculation.

When the road/object splitting method applied to the i-th tile is based on radius prediction through sensor position calculation, the base_height[i] field specifies the base height to a sensor applied to the i-th tile.

According to embodiments, the geometry slice bitstream (geometry_slice_bitstream( )) may include a geometry slice header (geometry_slice_header( )) and geometry slice data (geometry_slice_data( )).

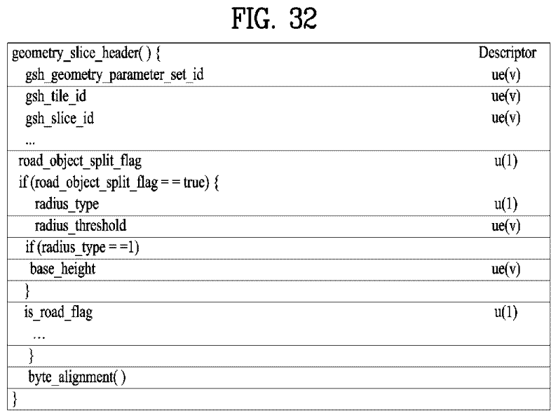

FIG. 32 is a diagram illustrating an embodiment of a syntax structure of a geometry slice header (geometry_slice_header( )) according to the present disclosure.

A bitstream transmitted by the transmission device (or a bitstream received by the reception device) according to the embodiments may contain one or more slices. Each slice may include a geometry slice and an attribute slice. The geometry slice includes a geometry slice header (GSH). The attribute slice includes an attribute slice header (ASH).

According to embodiments, inter-prediction-related option information (e.g., motion option information related to point road/object splitting) may be added to the geometry slice header and signaled for encoding/decoding of the geometry information on a slice-by-slice basis. In other words, by combining one or more pieces of inter-prediction-related option information included in the geometry slice header, inter-prediction of the geometry may be efficiently supported. As used herein, the names of signaling information may be understood within the scope of the meaning and functionality of the signaling information.

The geometry slice header (geometry_slice_header( )) according to embodiments may include at least a gsh_geometry_parameter_set_id field, a gsh_tile_id field, a gsh_slice_id field, or a road_object_split_flag field.

The gsh_geometry_parameter_set_id field specifies the value of the gps_geom_parameter_set_id of the active GPS.

The gsh_tile_id field specifies the identifier of the tile referenced by the geometry slice header (GSH).

The gsh_slice_id field specifies the identifier of the slice for reference by other syntax elements.

The road_object_split_flag field specifies whether road/object splitting is applied to the geometry slice. For example, when the value of the road_object_split_flag field is TRUE, it may indicate that road/object splitting is applied to the geometry slice.

When the value of road_object_split_flag is TRUE, the GSH according to the embodiments may further include a radius_type field and a radius_threshold field. When the value of the radius_type field is 1, the GSH may further include a base_height field.

The radius_type field specifies a radius calculation method for each laserID applied to the geometry slice. For example, radius_type equal to 0 may indicate an average radius basis, while radius_type equal to 1 may indicate radius prediction (i.e., expected radius) based on sensor position calculation. The method of separating roads and objects based on the average radius or expected radius has been described in detail above and will not be described below:

When the road/object splitting method applied to the geometry slice is based on the average radius, the radius_threshold field specifies a threshold of the point(s) to be excluded from the average radius calculation.

When the road/object splitting method applied to the geometry slice is based on radius prediction through sensor position calculation, the base_height field specifies the base height to a sensor applied to the geometry slice.

According to embodiments, the frame, tile, or slice may be divided into one or more LPUs based on the road/object splitting method. For example, a geometry slice may include a geometry slice header and one or more geometry LPUs. The one or more geometry LPUs may include an LPU composed of points of a road and an LPU composed of points of an object (or objects). Each LPU may include a geometry LPU header and geometry LPU data.

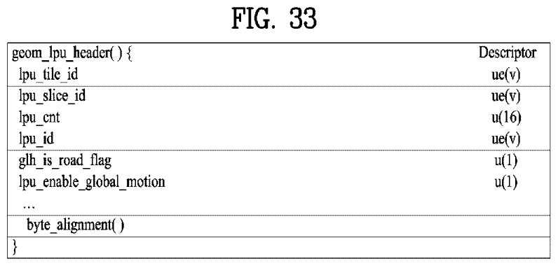

FIG. 33 is a diagram illustrating an embodiment of a syntax structure of a geometry LPU header (geom_lpu_header( )) that includes inter-prediction-related option information, according to embodiments. That is, the inter-prediction-related option information (also referred to as inter-prediction-related LPU information) may be signaled by generating a geometry LPU header.

According to embodiments, inter-prediction-related option information (e.g., motion option information related to point road/object splitting) may be added to the geometry LPU header and signaled for encoding/decoding of the geometry information on a LPU-by-LPU basis. In other words, by combining one or more pieces of inter-prediction-related option information included in the geometry LPU header, inter-prediction of the geometry may be efficiently supported. As used herein, the names of signaling information may be understood within the scope of the meaning and functionality of the signaling information.

The geometry LPU header according to the embodiments may include a lpu_tile_id field, a lpu_slice_id field, a lpu_cnt field, a lpu_id field, a glh_is_road_flag field, and a lpu_enable_global_motion field.

The lpu_tile_id field specifies a tile ID to identify the tile to which the LPU belongs.

The Ipu_slice_id field may specify a slice ID to identify the slice to which the LPU belongs.

The Ipu_cnt field specifies the number of PUs included in the LPU.

The glh_is_road_flag field specifies whether the points included in the LPU (i.e., LPU block) are a road/object. That is, it may indicate whether the points included in the LPU are points split into a road or points split into an object. In other words, the glh_is_road_flag field is information to identify whether the LPU is composed of points classified as a road or points classified as an object (or objects).

The lpu_enable_global_motion field specifies whether global motion is applied to the LPU (i.e., LPU block). For example, when the value of the glh_is_road_flag is TRUE, the value of lpu_enable global_motion may be FALSE. In other words, when the points included in the LPU are points separated into a road, global motion is not applied to the LPU.

According to embodiments, an LPU composed of points of an object group may be split into as many PUs as the number of objects in the object group. Each PU may include a geometry PU header and geometry PU data.

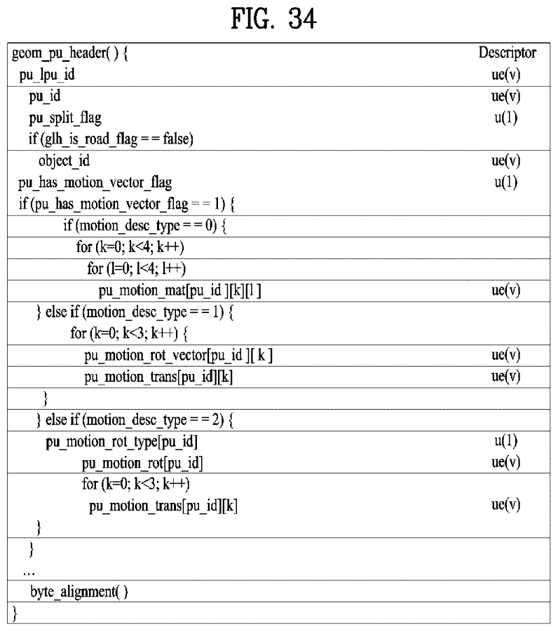

FIG. 34 is a diagram illustrating an embodiment of a syntax structure of a geometry PU header (geom_pu_header( )) that includes inter-prediction-related option information according to embodiments. That is, inter-prediction-related option information (also referred to as object split information about an inter-prediction-related PU) may be signaled by generating a geometry PU header.

According to embodiments, the inter-prediction-related option information (i.e., point road/object splitting-related motion option information) may be added to the geometry PU header and signaled for encoding/decoding of geometry information on a PU-by-PU basis. In other words, by combining one or more pieces of inter-prediction-related option information included in the geometry PU header, inter-prediction of the geometry may be efficiently supported. As used herein, the names of signaling information may be understood within the scope of the meaning and functionality of the signaling information.

The geometry PU header according to the embodiments may include a pu_lpu_id field, a pu_id field, a pu_split_flag field, and a pu_has_motion_vector_flag field.

The pu_Ipu_id field specifies the LPU ID to identify the LPU to which the PU belongs.

The pu_id field specifies the PU ID to identify the PU.

The pu_split_flag field specifies whether the PU block is subsequently further split.

When the value of glh_is_road_flag is FALSE, the geometry PU header may further include an object_id field if the points included in the LPU are points split into an object (or object group).

The object_id field specifies the object ID assigned to the PU among the PUs split from the LPU. In other words, object_id indicates object identification information to identify the object to which the points included in the PU block belong.

The pu_has_motion_vector_flag field specifies whether the PU block has a motion vector.

For example, pu_has_motion_vector_flag equal to 1 may indicate that the PU has a motion vector, and pu_has_motion_vector_flag equal to 0 may indicate that the PU does not have a motion vector.

When pu_has_motion_vector_flag is equal to 1, the geometry PU header may further include motion vector related information according to the value of motion_desc_type.

When motion_desc_type is equal to 0, the geometry PU header may further include a pu_motion_mat[pu_id][k][1] field.

The pu_motion_mat[pu_id][k][1] field specifies a motion matrix applied to the PU block identified by the pu_id field.

When motion_desc_type is equal to 1, the geometry PU header may further include a pu_motion_rot_vector[pu_id][k] field and a pu_motion_trans[pu_id][k] field.

The pu_motion_rot_vector[pu_id][k] field specifies a motion rotation vector applied to the PU block identified by the pu_id field.

The pu_motion_trans[pu_id][k] field specifies the motion translation vector applied to the PU block identified by the pu_id field above.

When motion_desc_type is equal to 2, the geometry PU header may further include a pu_motion_rot_type[pu_id] field, a pu_motion_rot[pu_id] field, and a pu_motion_trans[pu_id][k] field.

The pu_motion_rot_type[pu_id] field specifies the type of motion vector rotation type applied to the PU block identified by the pu_id field. For example, pu_motion_rot_type[pu_id] may indicate a radius when equal to 0, and indicate an angle (in degrees) when equal to 1.

The pu_motion_rot[pu_id] field specifies a motion rotation value applied to the PU block identified by the pu_id field. According to embodiments, the rotation axis about which rotation is performed is a road normal vector.

As described above, in a scenario where each frame is captured and stored by LiDAR equipment on a moving vehicle, there may be continuity between frames, and thus compression may be performed efficiently using an inter-prediction technique. In particular, since the captured road and object point clouds have different motion characteristics, the road and objects may be split to efficiently apply the inter-prediction technique. Thereby, the motion prediction may be performed quickly and accurately for each of the road and objects, reducing the compression time. Also, by increasing the efficiency of the inter-prediction technique through accurate prediction, the bitstream size may be reduced. Inaccurate motion prediction may significantly increase the bitstream size, and lower compression efficiency.

The embodiments propose a road/object splitting method to support efficient geometry compression of content captured by LiDAR equipment on a moving vehicle, allowing for fast and accurate motion prediction.

Thus, the embodiments may increase the inter-geometry compression efficiency of the G-PCC encoder/decoder to provide a point cloud content stream.

As such, the transmission method/device may efficiently compress the point cloud data to transmit the data, and may deliver the signaling information for the data. Thus, the reception method/device may efficiently decode/reconstruct the point cloud data.

Each part, module, or unit described above may be a software, processor, or hardware part that executes successive procedures stored in a memory (or storage unit). Each of the steps described in the above embodiments may be performed by a processor, software, or hardware parts. Each module/block/unit described in the above embodiments may operate as a processor, software, or hardware. In addition, the methods presented by the embodiments may be executed as code. This code may be written on a processor readable storage medium and thus read by a processor provided by an apparatus.

In the specification, when a part “comprises” or “includes” an element, it means that the part further comprises or includes another element unless otherwise mentioned. Also, the term “ . . . module (or unit)” disclosed in the specification means a unit for processing at least one function or operation, and may be implemented by hardware, software or combination of hardware and software.

Although embodiments have been explained with reference to each of the accompanying drawings for simplicity, it is possible to design new embodiments by merging the embodiments illustrated in the accompanying drawings. If a recording medium readable by a computer, in which programs for executing the embodiments mentioned in the foregoing description are recorded, is designed by those skilled in the art, it may fall within the scope of the appended claims and their equivalents.

The apparatuses and methods may not be limited by the configurations and methods of the embodiments described above. The embodiments described above may be configured by being selectively combined with one another entirely or in part to enable various modifications.

Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the apparatuses of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the apparatus according to the embodiments may include one or more processors capable of executing one or more programs. The one or more programs may perform any one or more of the operations/methods according to the embodiments or include instructions for performing the same. Executable instructions for performing the method/operations of the apparatus according to the embodiments may be stored in a non-transitory CRM or other computer program products configured to be executed by one or more processors, or may be stored in a transitory CRM or other computer program products configured to be executed by one or more processors. In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this document, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” “A, B, C” may also mean “at least one of A, B, and/or C.” Further, in the document, the term “or” should be interpreted as “and/or.” For instance, the expression “A or B” may mean 1) only A. 2) only B, and/or 3) both A and B. In other words, the term “or” in this document should be interpreted as “additionally or alternatively.”

Various elements of the embodiments may be implemented by hardware, software, firmware, or a combination thereof. Various elements in the embodiments may be executed by a single chip such as a single hardware circuit. According to embodiments, the element may be selectively executed by separate chips, respectively. According to embodiments, at least one of the elements of the embodiments may be executed in one or more processors including instructions for performing operations according to the embodiments.

Operations according to the embodiments described in this specification may be performed by a transmission/reception device including one or more memories and/or one or more processors according to embodiments. The one or more memories may store programs for processing/controlling the operations according to the embodiments, and the one or more processors may control various operations described in this specification. The one or more processors may be referred to as a controller or the like. In embodiments, operations may be performed by firmware, software, and/or combinations thereof. The firmware, software, and/or combinations thereof may be stored in the processor or the memory.

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signal unless context clearly dictates otherwise. The terminology used to describe the embodiments is used for the purpose of describing particular embodiments only and is not intended to be limiting of the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components.

As used herein, conditional expressions such as “if” and “when” are not limited to an optional case and are intended to be interpreted, when a specific condition is satisfied, to perform the related operation or interpret the related definition according to the specific condition. Embodiments may include variations/modifications within the scope of the claims and their equivalents. It will be apparent to those skilled in the art that various modifications and variations can be made in the present disclosure without departing from the spirit and scope of the disclosure. Thus, it is intended that the present disclosure cover the modifications and variations of this disclosure provided they come within the scope of the appended claims and their equivalents.

### Mode for Disclosure

As described above, related contents have been described in the best mode for carrying out the embodiments.

### INDUSTRIAL APPLICABILITY

As described above, the embodiments may be fully or partially applied to the point cloud data transmission/reception device and system. It will be apparent to those skilled in the art that variously changes or modifications may be made to the embodiments within the scope of the embodiments. Thus, it is intended that the embodiments cover the modifications and variations of this disclosure provided they come within the scope of the appended claims and their equivalents.

1. A method of transmitting point cloud data, the method comprising:
acquiring point cloud data comprising points through LiDAR equipment having laser sensors;
encoding the point cloud data; and
transmitting the encoded point cloud data and signaling data,
wherein the encoding comprises:
splitting the points of the point cloud data into a road and an object based on radius information about the points;
generating a prediction unit composed of points split into the road and a prediction unit composed of points split into the object; and
compressing the point cloud data by selectively applying a motion vector to each of the prediction units,
wherein the signaling data comprises information related to the splitting into the road and the object.

2. The method of claim 1, wherein the splitting into the road and the object comprises:
removing points present within a minimum radius among points acquired through a current laser sensor and splitting remaining points among the acquired points into the road and the object.

3. The method of claim 1, wherein the splitting into the road and the object comprises:
splitting points present within a minimum radius among points acquired through a current laser sensor into the road.

4. The method of claim 1, wherein the splitting into the road and the object comprises:
obtaining an average radius of radii at which the points are located for the laser sensors;
based on a radius of the points acquired through a current laser sensor being less than the average radius at a previous laser sensor, splitting the points into the object; and
based on the radius not being less than the average radius, splitting the points into the road.

5. The method of claim 4, wherein the splitting into the road and the object comprises:
excluding, from the average radius, points located at a radius greater than a specific threshold among the points.

6. The method of claim 4, wherein the splitting into the road and the object comprises:
based on a radius at successive azimuths at the same laser sensor being outside a specific range, splitting corresponding points into the object; and
based on the radius not being outside the specific range, splitting the corresponding points into the road.

7. The method of claim 1, wherein the splitting into the road and the object comprises:
predicting radii at which the points are located for the laser sensors and obtaining an expected radius;
based on a radius of the points acquired through a current laser sensor being less than an expected radius at a previous laser sensor, splitting the points into the object; and
based on the radius not being less than the expected radius, splitting the points into the road.

8. The method of claim 1, further comprising:
performing motion compensation on the prediction unit composed of the points split into the object by applying the motion vector; and
skipping motion compensation for the prediction unit composed of the points split into the road.

9. A device for transmitting point cloud data, comprising:
an acquirer configured to acquire point cloud data comprising points through LiDAR equipment having laser sensors;
an encoder configured to encode the point cloud data; and
a transmitter configured to transmit the encoded point cloud data and signaling data,
wherein the encoder comprises:
a road/object splitter configured to split the points of the point cloud data into a road and an object based on radius information about the points;
a prediction unit splitter configured to generate a prediction unit composed of points split into the road and a prediction unit composed of points split into the object; and
a compressor configured to compress the point cloud data by selectively applying a motion vector to each of the prediction units,
wherein the signaling data comprises information related to the splitting into the road and the object.

10. The device of claim 9, wherein the road/object splitter removes points present within a minimum radius among points acquired through a current laser sensor, and splits remaining points among the acquired points into the road and the object.

11. The device of claim 9, wherein the road/object splitter is configured to:
obtain an average radius of radii at which the points are located for the laser sensors;
based on a radius of the points acquired through a current laser sensor being less than the average radius at a previous laser sensor, split the points into the object; and
based on the radius not being less than the average radius, split the points into the road.

12. The device of claim 11, wherein the road/object splitter excludes, from the average radius, points located at a radius greater than a specific threshold among the points.

13. The device of claim 12, wherein the road/object splitter is configured to:
based on a radius at successive azimuths at the same laser sensor being outside a specific range, split corresponding points into the object; and
based on the radius not being outside the specific range, split the corresponding points into the road.

14. The device of claim 9, wherein the road/object splitter is configured to:
predict radii at which the points are located for the laser sensors and obtaining an expected radius;
based on a radius of the points acquired through a current laser sensor being less than an expected radius at a previous laser sensor, split the points into the object; and
based on the radius not being less than the expected radius, split the points into the road.

15. The device of claim 9, wherein motion compensation is performed on the prediction unit composed of the points split into the object by applying the motion vector, and
wherein the motion compensation is skipped for the prediction unit composed of the points split into the road.
